(19) United States
(12) Patent Application Publication
(10) Pub. No.: US 2026/0140511 A1
(43) Pub. Date: May 21, 2026

(54) TOY SYSTEM, MOVING BODY, CONTROL METHOD, AND PROGRAM

(71) Applicant: Sony Interactive Entertainment Inc., Tokyo (JP)

(72) Inventors: Yuya Hirano, Kanagawa (JP); Takuya Nishijima, Tokyo (JP); Kazuhiro Yabe, Tokyo (JP)

(73) Assignee: Sony Interactive Entertainment Inc., Tokyo (JP)

(21) Appl. No.: 19/451,820

(22) Filed: Jan. 16, 2026

Related U.S. Application Data
(63) Continuation of application No. PCT/JP2024/018899, filed on May 22, 2024.

(30) Foreign Application Priority Data
Jul. 20, 2023 (JP) 2023-118236
Sep. 13, 2023 (JP) 2023-148374
Sep. 13, 2023 (JP) 2023-148375
Sep. 13, 2023 (JP) 2023-148376
Sep. 25, 2023 (JP) 2023-160335
Oct. 19, 2023 (JP) 2023-180409

(51) Int. Cl. G05D 1/646; A63H 17/26; G05D 1/244; G05D 105/30; G05D 109/10; G05D 111/10

(52) U.S. Cl. CPC G05D 1/646; A63H 17/26; G05D 1/2446; G05D 2105/32; G05D 2109/10; G05D 2111/10

(57) ABSTRACT

For a user to experience programming more intuitively. A toy system includes a traveling module for enabling traveling, a reading module for, when traveling on any one of a plurality of cards each printed with a coded image indicating any one of a plurality of operation states and each disposed at any position by a user, reading the image, and an operation control module for controlling the traveling module according to an operation instruction indicated by the read image, the operation control module being configured to, when the coded image is not read, control the traveling module so as to continue an operation corresponding to an operation instruction indicated by a previously read image until a new coded image is read by traveling on a new card among the plurality of cards, and when the new coded image is read, control the traveling module according to a new operation instruction indicated by the new image.

### CROSS-REFERENCES TO RELATED APPLICATIONS

This application is a U.S. Continuation application under 35 U.S.C. § 111 of International Patent Application No. PCT/JP2024/018899, filed on May, 2024, which claims priority to Japanese patent application 2023-118236, filed on Jul. 20, 2023, Japanese patent application 2023-148374, filed on Sep. 13, 2023, Japanese patent application 2023-148375, filed on Sep. 13, 2023, Japanese patent application 2023-148376, filed on Sep. 13, 2023, Japanese patent application 2023-160335, filed on Sep. 25, 2023, Japanese patent application 2023-180409, filed on Oct. 19, 2023, the entire disclosures of which are incorporated herein by reference for all purposes.

The present invention relates to a toy system, a moving body, a control method, and a program.

### BACKGROUND OF THE INVENTION

For learning of programming, a teaching material is sold in which programming is performed by arranging physical cards describing commands. A self-propelled device reads the command of an arranged card, and then the self-propelled device performs an operation corresponding to the read command.

In addition, there is a system in which a plurality of patterns associated with information different from positional information are printed on one surface of a sheet-shaped medium, and a moving body traveling on the card is thereby controlled.

In addition, there is a toy system in which cards are arranged on a flat surface of a desk or the like, and a moving body travels over the cards.

PCT Patent Publication No. WO 2020/036146 discloses that a moving body travels over arranged instruction cards, the moving body recognizes a pattern printed on an instruction card, and obtains a command for controlling operation of the moving body from the pattern. In addition, PCT Patent Publication No. WO 2020/036146 discloses that a self-propelled device reads a program by reading images printed on arranged cards while traveling on the cards, and then the self-propelled device travels on a maze according to the program.

PCT Patent Publication No. WO 2018/025467 discloses that a carriage travels on a sheet-shaped medium printed with a plurality of second array patterns defining control information, and the traveling of the carriage is controlled by reading the patterns printed on the medium.

### BRIEF SUMMARY OF THE INVENTION

### Technical Problem

In a method of reading a program in advance, the reading of the program and execution according to the program are separated from each other. It is therefore difficult for some people to grasp a relation between the program and operation intuitively, which may be a hindrance to the learning of programming.

The present invention has been made in view of the above-described problems. It is one of objects of the present invention to provide a technology that makes it possible to experience programming more intuitively.

In addition, the inventor et al., has developed a system that controls operation of a moving body by using a plurality of cards, which are each sheet-shaped medium. Here, in a case where a plurality of cards printed with patterns obtained by coding same information are arranged consecutively, even when the moving body traveling on a card moves onto a next card, read information does not change. It is therefore difficult for the moving body to correctly recognize whether the information is obtained from one card or whether the information is obtained from a plurality of cards.

The present invention has been made in view of the above-described problems. It is one of objects of the present invention to provide a technology that can correctly obtain information from a plurality of cards printed with patterns obtained by coding information.

In addition, depending on an environment in which the cards are arranged, when the moving body travels over a card, the position of the card may be shifted. Due to such a phenomenon, it is difficult for the moving body to travel stably.

The present invention has been made in view of the above-described problems. It is one of objects of the present invention to provide a technology that enables stable traveling of a moving body.

### Solution to Problem

In order to solve any one of the above-described problems, a toy system according to the present invention includes a plurality of operation instruction cards each printed with a coded image indicating any one of a plurality of operation instructions, and each disposed at any position by a user, and a moving body, the moving body including a traveling module for enabling traveling, a reading module for reading the image when the moving body travels over any one of the plurality of operation instruction cards, and an operation control module for controlling the traveling module according to the operation instruction indicated by the read image, and the operation control module being configured to, when the coded image is not read, control the traveling module so as to continue an operation corresponding to an operation instruction indicated by a previously read image until the moving body reads a new coded image by traveling on a new operation instruction card among the plurality of operation instruction cards, and when the new coded image is read, control the traveling module according to a new operation instruction indicated by the new image.

In order to solve any one of the above-described problems, a moving body according to the present invention includes a traveling module for enabling traveling, a reading module for, when the moving body travels over any one of a plurality of operation instruction cards each printed with a coded image indicating any one of a plurality of operation instructions and each disposed at any position by a user, reading the image, and an operation control module for controlling the traveling module according to the operation instruction indicated by the read image, the operation control module being configured to, when the coded image is not read, control the traveling module so as to continue an operation corresponding to an operation instruction indicated by a previously read image until the moving body reads a new coded image by traveling on a new operation instruction card among the plurality of operation instruction cards, and when the new coded image is read, control the traveling module according to a new operation instruction indicated by the new image.

In addition, a control method according to the present invention is a control method for controlling traveling of a moving body including a reading module and a traveling module, the control method including a step of, when the moving body travels over any one of a plurality of operation instruction cards each printed with a coded image indicating any one of a plurality of operation instructions and each disposed at any position by a user, reading the image by the reading module, and a step of controlling the traveling module according to the operation instruction indicated by the read image, in the step of controlling the traveling module, when the coded image is not read, the traveling module being controlled so as to continue an operation corresponding to an operation instruction indicated by a previously read image until the moving body reads a new coded image by traveling on a new operation instruction card among the plurality of operation instruction cards, and when the new coded image is read, the traveling module being controlled according to a new operation instruction indicated by the new image.

In addition, a program according to the present invention makes a computer including a traveling module operate as a reading module for, when the computer travels on any one of a plurality of operation instruction cards each printed with a coded image indicating any one of a plurality of operation instructions and each disposed at any position by a user, reading the image, and an operation control module for controlling the traveling module according to the operation instruction indicated by the read image, the operation control module being configured to, when the coded image is not read, control the traveling module so as to continue an operation corresponding to an operation instruction indicated by a previously read image until the computer reads a new coded image by traveling on a new operation instruction card among the plurality of operation instruction cards, and when the new coded image is read, control the traveling module according to a new operation instruction indicated by the new image.

According to the present invention, the user can experience programming more intuitively.

In an embodiment of the present invention, the plurality of operation instructions may be classified into a plurality of groups, and the operation control module may update a setting of a group to which the operation instruction indicated by the read image belongs among the plurality of groups to information indicated by the operation instruction.

In an embodiment of the present invention, the plurality of operation instructions may include a steering instruction to continuously change a traveling direction to the right or the left, and the operation control module may control the traveling module so as to continuously change the traveling direction of the moving body to the right or the left after an image indicating the steering instruction is read.

In an embodiment of the present invention, the plurality of operation instructions may include a speed at which the moving body travels, and after an image indicating the speed is read, the operation control module may control the traveling module such that the moving body travels according to the speed.

In an embodiment of the present invention, the plurality of operation instructions may include a brake instruction to continuously decrease a speed of the moving body, and after an image indicating the brake instruction is read, the operation control module may continuously decrease the speed of the moving body.

In an embodiment of the present invention, the operation control module may control the traveling module on a basis of the information set for each of the plurality of groups according to the operation instruction indicated by the previously read image.

In an embodiment of the present invention, the plurality of operation instructions may include a traveling direction, and when an image indicating the traveling direction is read, the operation control module may control the traveling module such that the moving body turns to the traveling direction and continues an operation before the turning.

In order to solve any one of the above-described problems, a toy system according to the present invention includes a plurality of operation instruction cards each printed with a coded image indicating any one of a plurality of operation instructions, and each disposed by a user, and a moving body, the moving body including a traveling module for enabling traveling, a reading module for reading the image when the moving body travels over any one of the plurality of operation instruction cards, and an operation control module for controlling the traveling module according to the operation instruction indicated by the read image, the operation control module being configured to, when the moving body reads the coded image by traveling on one of the plurality of operation instruction cards, control the traveling module according to the operation instruction indicated by the image, the plurality of operation instructions including a steering instruction to continuously change a traveling direction to a right or a left, and the operation control module being configured to, after an image indicating the steering instruction is read, control the traveling module so as to change the traveling direction to the right or the left with a turning radius corresponding to a present speed of the moving body.

In order to solve any one of the above-described problems, a moving body according to the present invention includes a traveling module for enabling traveling, a reading module for, when the moving body travels over any one of a plurality of operation instruction cards each printed with a coded image indicating any one of a plurality of operation instructions and each disposed by a user, reading the image, and an operation control module for controlling the traveling module according to the operation instruction indicated by the read image, the operation control module being configured to, when the moving body reads the coded image by traveling on any one of the plurality of operation instruction cards, control the traveling module according to the operation instruction indicated by the image, the plurality of operation instructions including a steering instruction to continuously change a traveling direction to a right or a left, and the operation control module being configured to, after an image indicating the steering instruction is read, control the traveling module so as to change the traveling direction to the right or the left with a turning radius corresponding to a present speed.

In addition, a control method according to the present invention is a control method for controlling traveling of a moving body including a reading module and a traveling module, the control method including a step of, when the moving body travels over any one of a plurality of operation instruction cards each printed with a coded image indicating any one of a plurality of operation instructions and each disposed by a user, reading the image by the reading module, and a step of controlling the traveling module according to the operation instruction indicated by the read image, when the moving body reads the coded image by traveling on any one of the plurality of operation instruction cards, the step of controlling the traveling module controlling the traveling module according to the operation instruction indicated by the image, the plurality of operation instructions including a steering instruction to continuously change a traveling direction to a right or a left, and after an image indicating the steering instruction is read, the step of controlling the traveling module controlling the traveling module so as to change the traveling direction to the right or the left with a turning radius corresponding to a present speed.

In addition, a program according to the present invention makes a computer including a traveling module function as a reading module for, when the computer travels on any one of a plurality of operation instruction cards each printed with a coded image indicating any one of a plurality of operation instructions and each disposed by a user, reading the image, and an operation control module for controlling the traveling module according to the operation instruction indicated by the read image, the operation control module being configured to, when the computer reads the coded image by traveling on any one of the plurality of operation instruction cards, control the traveling module according to the operation instruction indicated by the image, the plurality of operation instructions including a steering instruction to continuously change a traveling direction to a right or a left, and the operation control module being configured to, after an image indicating the steering instruction is read, control the traveling module so as to change the traveling direction to the right or the left with a turning radius corresponding to a present speed.

In addition, a card set according to the present invention includes a plurality of operation instruction cards each printed with a coded image indicating any one of a plurality of operation instructions, and each disposed by a user, the coded image being an image read when a moving body including a traveling module for enabling traveling travels, the plurality of operation instructions including a steering instruction to continuously change a traveling direction to a right or a left, when the image indicating any one of the plurality of operation instructions is read, the traveling module being controlled according to the operation instruction indicated by the image, and after an image indicating the steering instruction is read, the traveling module being controlled so as to change the traveling direction to the right or the left with a turning radius corresponding to a present speed of the moving body.

According to the present invention, the user can experience programming more intuitively.

In an embodiment of the present invention, the plurality of operation instructions may further include a speed at which the moving body travels, and after an image indicating the speed is read, the operation control module may control the traveling module such that the moving body travels according to the speed.

In an embodiment of the present invention, the plurality of operation instructions may further include a brake instruction to continuously decrease a speed of the moving body, and after an image indicating the brake instruction is read, the operation control module may continuously decrease the speed of the moving body so as to stop at a braking distance corresponding to the speed.

In an embodiment of the present invention, after the image indicating the brake instruction and the image indicating the steering instruction are read, the operation control module may control the traveling module so as to change direction to the right or the left while monotonically decreasing the turning radius.

In order to solve any one of the above-described problems, a toy system according to the present invention includes a plurality of operation instruction cards each printed with a coded image indicating any one of a plurality of operation instructions, and each disposed at any position by a user, and a moving body, the moving body including a traveling module for enabling traveling, a reading module for reading the image when the moving body travels over any one of the plurality of operation instruction cards, and an operation control module for controlling the traveling module according to the operation instruction indicated by the read image, the operation control module being configured to, when the moving body reads the coded image by traveling on any one of the plurality of operation instruction cards, control the traveling module according to the operation instruction indicated by the image, the operation control module being configured to, when a recording instruction is obtained, each time the moving body reads a coded image by traveling on a new operation instruction card, store an operation instruction indicated by the image and time information indicating a present time in a storage, and the operation control module being configured to control the traveling module according to the stored time information and the stored operation instruction when a reproduction instruction is obtained.

In order to solve any one of the above-described problems, a moving body according to the present invention includes a traveling module for enabling traveling, a reading module for, when the moving body travels over any one of a plurality of operation instruction cards each printed with a coded image indicating any one of a plurality of operation instructions and each disposed at any position by a user, reading the image, and an operation control module for controlling the traveling module according to the operation instruction indicated by the read image, the operation control module being configured to, when the moving body reads the coded image by traveling on any one of the plurality of operation instruction cards, control the traveling module according to the operation instruction indicated by the image, the operation control module being configured to, when a recording instruction is obtained, each time the moving body reads a coded image by traveling on a new operation instruction card, store an operation instruction indicated by the image and time information indicating a present time in a storage, and the operation control module being configured to control the traveling module according to the stored time information and the stored operation instruction when a reproduction instruction is obtained.

In addition, a control method according to the present invention is a control method for controlling traveling of a moving body including a reading module and a traveling module, the control method including a step of, when the moving body travels over any one of a plurality of operation instruction cards each printed with a coded image indicating any one of a plurality of operation instructions and each disposed at any position by a user, reading the image by the reading module, and a step of controlling the traveling module according to the operation instruction indicated by the read image, the step of controlling the traveling module further including a step of, when the moving body reads the coded image by traveling on any one of the plurality of operation instruction cards, controlling the traveling module according to the operation instruction indicated by the image, and when a recording instruction is obtained, each time the moving body reads a coded image by traveling on a new operation instruction card, storing an operation instruction indicated by the image and time information indicating a present time in a storage, and a step of controlling the traveling module according to the stored time information and the stored operation instruction when a reproduction instruction is obtained.

In addition, a program according to the present invention makes a computer including a traveling module function as a reading module for, when the computer travels on any one of a plurality of operation instruction cards each printed with a coded image indicating any one of a plurality of operation instructions and each disposed at any position by a user, reading the image, and an operation control module for controlling the traveling module according to an operation state indicated by the read image, the operation control module being configured to, when the moving body reads the coded image by traveling on any one of the plurality of operation instruction cards, control the traveling module according to the operation instruction indicated by the image, the operation control module being configured to, when a recording instruction is obtained, each time the moving body reads a coded image by traveling on a new operation instruction card, store an operation instruction indicated by the image and time information indicating a present time in a storage, and the operation control module being configured to control the traveling module according to the stored time information and the stored operation instruction when a reproduction instruction is obtained.

In addition, a card set according to the present invention includes a plurality of operation instruction cards each printed with a coded image indicating any one of a plurality of operation instructions, and each disposed at any position by a user, the coded image being an image read when a moving body including a traveling module for enabling traveling and a storage travels, a recording instruction card printed with a coded image indicating a recording instruction, and a reproduction instruction card printed with a coded image indicating a reproduction instruction, when the moving body reads the image indicating the operation instruction, the traveling module being controlled according to the operation instruction, when the moving body reads the image indicating the recording instruction, each time the moving body reads a coded image by traveling on a new operation instruction card, an operation instruction indicated by the image and time information indicating a present time being stored in the storage, and when the moving body reads the image indicating the reproduction instruction, the traveling module being controlled according to the stored time information and the stored operation instruction.

According to the present invention, the user can experience programming more intuitively.

In an embodiment of the present invention, when the recording instruction is obtained, the operation control module may store an operation state of the moving body at a time of the obtainment of the recording instruction in the storage, and when the reproduction instruction is obtained, the operation control module may control the traveling module according to the stored time information and the stored operation instruction after controlling the traveling module so as to produce the stored operation state.

In an embodiment of the present invention, the toy system may further include a recording instruction card printed with a coded image indicating the recording instruction and a reproduction instruction card printed with a coded image indicating the reproduction instruction, in which the reading module may read the images respectively printed on the recording instruction card and the reproduction instruction card when the moving body travels over the recording instruction card and the reproduction instruction card, and when the image indicating the recording instruction is read, each time the moving body reads a coded image by traveling on a new operation instruction card, the operation control module may store an operation instruction indicated by the image and time information indicating the present time in the storage, and when the image indicating the reproduction instruction is read, the operation control module may control the traveling module according to the stored time information and the stored operation instruction.

In an embodiment of the present invention, the reading module repeats reading the image when the moving body travels over any one of the plurality of operation instruction cards after the image indicating the recording instruction is read, and the operation control module does not have to store the operation instruction indicated by the image and the time information indicating the present time in the storage when the operation instruction indicated by the image read this time is the same as an operation instruction indicated by an image read last time.

In an embodiment of the present invention, the toy system may further include a recording end card printed with a coded image indicating a recording end instruction, in which when the moving body travels over the recording end card, the reading module reads the image printed on the recording end card, and when the image indicating the recording instruction is read, each time the moving body reads a coded image by traveling on a new operation instruction card, the operation control module may store an operation instruction indicated by the image and time information indicating the present time in the storage until the image indicating the recording end instruction is read.

In an embodiment of the present invention, when the coded image is not read, the traveling module may be controlled so as to continue an operation corresponding to an operation instruction indicated by a previously read image until the moving body reads a new coded image by traveling on a new operation instruction card among the plurality of operation instruction cards, and when the new coded image is read, the traveling module may be controlled according to an operation instruction indicated by the new image.

In order to solve any one of the above-described problems, a toy system according to the present invention includes a plurality of operation instruction cards each printed with a coded image indicating any one of a plurality of operation instructions, an interrupt setting card printed with a coded image indicating an interrupt recording instruction associated with an execution condition, and a moving body. The moving body includes a traveling module for enabling traveling, a reading module for, when the moving body travels over any one of the interrupt setting card and the plurality of operation instruction cards, reading the image, and an operation control module for controlling the traveling module according to the operation instruction indicated by the image read from any one of the plurality of operation instruction cards, the operation control module being configured to, when the moving body reads the coded image by traveling on any one of the plurality of operation instruction cards, control the traveling module according to the operation instruction indicated by the image, the operation control module being configured to, when the image indicating the interrupt recording instruction is read, store, in association with the execution condition, an operation instruction indicated by an image read from an operation instruction card on which the moving body travels next, and the operation control module being configured to, when the execution condition is satisfied, perform an operation corresponding to the operation instruction stored in association with the execution condition, and after performing the operation, resume an operation before the execution condition is satisfied.

In addition, a moving body according to the present invention includes a traveling module for enabling traveling, a reading module for, when the moving body travels over any one of a plurality of operation instruction cards each printed with a coded image indicating any one of a plurality of operation instructions and an interrupt setting card printed with a coded image indicating an interrupt recording instruction associated with an execution condition, reading the image, and an operation control module for controlling the traveling module according to the operation instruction indicated by the image read from any one of the plurality of operation instruction cards. When the coded image is read by traveling on any one of the plurality of operation instruction cards, the operation control module controls the traveling module according to the operation instruction indicated by the image, when the image indicating the interrupt recording instruction is read, the operation control module stores, in association with the execution condition, an operation instruction indicated by an image read from an operation instruction card on which the moving body travels next, and when the execution condition is satisfied, the operation control module performs an operation corresponding to the operation instruction associated with the execution condition, and after performing the operation, resumes an operation before the execution condition is satisfied.

In addition, a card set according to the present invention includes a plurality of operation instruction cards each printed with a coded image indicating any one of a plurality of operation instructions, and each disposed by a user, the coded image being an image read when a moving body including a traveling module for enabling traveling travels, and an interrupt setting card printed with a coded image indicating an interrupt recording instruction associated with an execution condition. When the image indicating any one of the plurality of operation instructions is read, the traveling module is controlled according to the operation instruction indicated by the image, when the image indicating the interrupt recording instruction is read, an operation instruction indicated by an image read from an operation instruction card on which the moving body travels next is stored in association with the execution condition, and when the execution condition is satisfied, an operation corresponding to the operation instruction stored in association with the execution condition is performed, and after the operation is performed, an operation before the execution condition is satisfied is resumed.

In addition, a control method according to the present invention is a control method for controlling traveling of a moving body including a reading module and a traveling module, the control method including a step of, when the moving body travels over any one of a plurality of operation instruction cards each printed with a coded image indicating any one of a plurality of operation instructions and each disposed by a user and an interrupt setting card printed with a coded image indicating an interrupt recording instruction associated with an execution condition, reading the image by the reading module, and a step of controlling the traveling module according to an operation instruction indicated by the read image, the step of controlling the traveling module further including a step of, when the moving body reads the coded image by traveling on any one of the plurality of operation instruction cards, controlling the traveling module according to the operation instruction indicated by the image, and when the image indicating the interrupt recording instruction is read, storing, in association with the execution condition, an operation instruction indicated by an image read from an operation instruction card on which the moving body travels next, and when the execution condition is satisfied, the step of controlling the traveling module performing an operation corresponding to the operation instruction associated with the execution condition, and after performing the operation, resuming an operation before the execution condition is satisfied.

In addition, a program according to the present invention makes a computer including a traveling module function as a reading module for, when the computer travels on any one of a plurality of operation instruction cards each printed with a coded image indicating any one of a plurality of operation instructions and an interrupt setting card printed with a coded image indicating an interrupt recording instruction associated with an execution condition, reading the image, and an operation control module for controlling the traveling module according to an operation instruction indicated by an image read from the plurality of operation instruction cards, the operation control module being configured to, when the computer reads the coded image by traveling on any one of the plurality of operation instruction cards, control the traveling module according to the operation instruction indicated by the image, the operation control module being configured to, when the image indicating the interrupt recording instruction is read, store, in association with the execution condition, an operation instruction indicated by an image read from an operation instruction card on which the moving body travels next, and the operation control module being configured to, when the execution condition is satisfied, perform an operation corresponding to the operation instruction associated with the execution condition, and after performing the operation, resume an operation before the execution condition is satisfied.

According to the present invention, the user can experience programming more intuitively.

In an embodiment of the present invention, the execution condition may be passage of a predetermined period from a start time or from a previous satisfaction of the execution condition.

In an embodiment of the present invention, the execution condition may include a first condition and a second condition, the first condition may be passage of a first period from the start time or a previous performance according to the first condition, the second condition may be passage of a second period longer than the first period from the start time or a previous performance according to the second condition, and when the second condition is satisfied, the operation control module may perform an operation corresponding to only an operation instruction associated with the second condition irrespective of whether the first condition is satisfied, and after performing the operation, the operation control module may resume an operation before the execution condition is satisfied.

In an embodiment of the present invention, the execution condition may be detection of an impact on the moving body by an acceleration sensor.

In an embodiment of the present invention, the execution condition may be detection of magnetism satisfying a detection condition by a magnetic sensor.

In an embodiment of the present invention, the execution condition may be reading, by the reading module, of an image obtained by coding information corresponding to the execution condition.

In an embodiment of the present invention, when the image indicating the interrupt recording instruction is read, the operation control module may make the moving body travel in a predetermined direction on the basis of an orientation of the moving body obtained from the image, and store, in association with the execution condition, an operation instruction indicated by an image read from an operation instruction card on which the moving body travels next and which is disposed in the predetermined direction.

In order to solve another one of the above-described problems, a card set according to the present invention includes a plurality of cards classified into a plurality of types, each of the plurality of cards having a surface including an inner region and a peripheral region surrounding the inner region, the inner region of each of the plurality of cards being printed with a plurality of identification patterns that are imaged by a moving body traveling on the card and indicate a type to which the card itself belongs, and the peripheral region of each of the plurality of cards not being printed with an identification pattern indicating any one of the plurality of types.

In an embodiment of the present invention, the peripheral region may be disposed at a peripheral edge of each of the plurality of cards.

In an embodiment of the present invention, the peripheral region may be printed with a pattern not indicating any of the plurality of types.

In an embodiment of the present invention, the plurality of identification patterns may be arranged within the inner region, and the plurality of peripheral patterns may be arranged so as to surround the inner region.

In addition, a toy system according to the present invention includes a plurality of cards classified into a plurality of types, and a moving body including a camera configured to repeat imaging, each of the plurality of cards having a surface including an inner region and a peripheral region surrounding the inner region, the inner region of each of the plurality of cards being printed with a plurality of identification patterns indicating a type to which the card itself belongs, the peripheral region of each of the plurality of cards being printed with a peripheral pattern different from any of patterns indicating the types, and when the camera images any one of the plurality of identification patterns after imaging the peripheral pattern, operation of the moving body being controlled on the basis of the imaged identification pattern.

In an embodiment of the present invention, when the camera images the same identification pattern as last time, the operation of the moving body may not be controlled on the basis of the imaged identification pattern.

According to the present invention, information can be obtained correctly from the plurality of cards printed with the patterns obtained by coding the information.

In order to solve another one of the above-described problems, a toy system according to the present invention includes a moving body self-propellable by a rotating wheel, and a card on which the moving body can travel, the card including one sheet or a plurality of sheets superposed on each other, and a friction coefficient of an underside surface of the card being higher than a friction coefficient of a top side surface of the card.

In an embodiment of the present invention, the underside surface of the card may be subjected to surface processing that makes the underside surface of the card higher in friction coefficient than the top side surface of the card.

In an embodiment of the present invention, the card includes one sheet, and a top side surface of the sheet may be printed with a pattern readable by the moving body and obtained by coding information for controlling movement of the moving body.

In an embodiment of the present invention, the card may include a sheet as a base material and two sheets respectively constituting the top side surface and the underside surface of the card, and a material of the sheet constituting the top side surface of the card may be the same as a material of the sheet constituting the underside surface of the card.

In an embodiment of the present invention, the sheet constituting the top side surface of the card and the sheet constituting the underside surface of the card may include the same kind of resin.

In an embodiment of the present invention, a top side surface of the base material may be printed with a visually recognizable image.

In an embodiment of the present invention, a top side surface of the base material may be printed with a pattern readable by the moving body and obtained by coding information for controlling movement of the moving body.

In addition, a card according to the present invention is a card on which a self-propellable moving body can travel, the card including one sheet or a plurality of sheets superposed on each other, and a friction coefficient of an underside surface of the card being higher than a friction coefficient of a top side surface of the card.

In an embodiment of the present invention, the card may be printed with a pattern that is read by the moving body and obtained by coding information for controlling movement of the moving body.

According to the present invention, the moving body can stably travel over cards.

### BRIEF DESCRIPTION OF THE DRAWINGS

FIG. 1 is a view depicting an example of a toy system according to an embodiment of the present invention.

FIG. 2 is a view depicting an example of a hardware configuration of the toy system.

FIG. 3 is a view of an example of a moving body as viewed from below.

FIG. 4 is a view depicting an example of a relation between information printed on a card and the moving body.

FIG. 5 is a block diagram depicting functions implemented by the toy system.

FIG. 6 is a view of assistance in explaining an example of control of the moving body by cards.

FIG. 7 is a view of assistance in explaining another example of control of the moving body by cards.

FIG. 8 is a view of assistance in explaining another example of control of the moving body by cards.

FIG. 9 is a flowchart depicting an example of processing of the moving body.

FIG. 10 is a flowchart depicting an example of processing of the moving body.

FIG. 11 is a flowchart depicting an example of traveling processing by a traveling processing section.

FIG. 12 is a view of assistance in explaining an example of a difference in an operation of the moving body according to speed.

FIG. 13 is a view of assistance in explaining another example of a difference in the operation of the moving body according to speed.

FIG. 14 is a view of assistance in explaining another example of a difference in the operation of the moving body according to speed.

FIG. 15 is a view of assistance in explaining another example of a difference in the operation of the moving body according to speed.

FIG. 16 is a flowchart depicting an example of action processing by an action processing section.

FIG. 17 is a view of assistance in explaining an example of a card.

FIG. 18 is a flowchart depicting another example of the processing of the moving body.

FIG. 19 is a flowchart depicting another example of the processing of the moving body.

FIG. 20 is a view depicting an example of a plurality of arranged cards.

FIG. 21 is a view of assistance in explaining an example of operation of the moving body for a plurality of arranged cards.

FIG. 22 is a view of assistance in explaining another example of operation of the moving body for a plurality of arranged cards.

FIG. 23 is a schematic sectional view of a card.

FIG. 24 is a view of assistance in explaining an example of the moving body traveling on a card.

FIG. 25 is a block diagram depicting functions implemented by the toy system.

FIG. 26 is a view of assistance in explaining an example of recording of operation instructions.

FIG. 27 is a view of assistance in explaining an example of reproduction of recorded operation instructions.

FIG. 28 is a flowchart depicting an example of processing of the moving body.

FIG. 29 is a flowchart depicting an example of processing of the moving body.

FIG. 30 is a flowchart depicting an example of processing of the moving body.

FIG. 31 is a view depicting an example of stored operation instructions and the like.

FIG. 32 is a view depicting another example of the hardware configuration of the toy system.

FIG. 33 is a block diagram depicting functions implemented by the toy system.

FIG. 34 is a view of assistance in explaining an example of setting an interrupt operation.

FIG. 35 is a view depicting a modification of an interrupt setting card.

FIG. 36 is a view of assistance in explaining an example of operation according to the interrupt setting depicted in FIG. 9.

FIG. 37 is a view of assistance in explaining an example of operation according to an interrupt execution card.

FIG. 38 is a flowchart depicting an example of processing of the moving body.

FIG. 39 is a flowchart depicting an example of processing of the moving body.

FIG. 40 is a flowchart depicting an example of processing of the moving body.

FIG. 41 is a flowchart depicting an example of processing for operating the moving body according to an interrupt execution condition.

### DESCRIPTION OF EMBODIMENT

An embodiment of the present invention will hereinafter be described with reference to the drawings. Constituent elements having same functions among constituent elements that appear are given the same reference signs, and description thereof will be omitted.

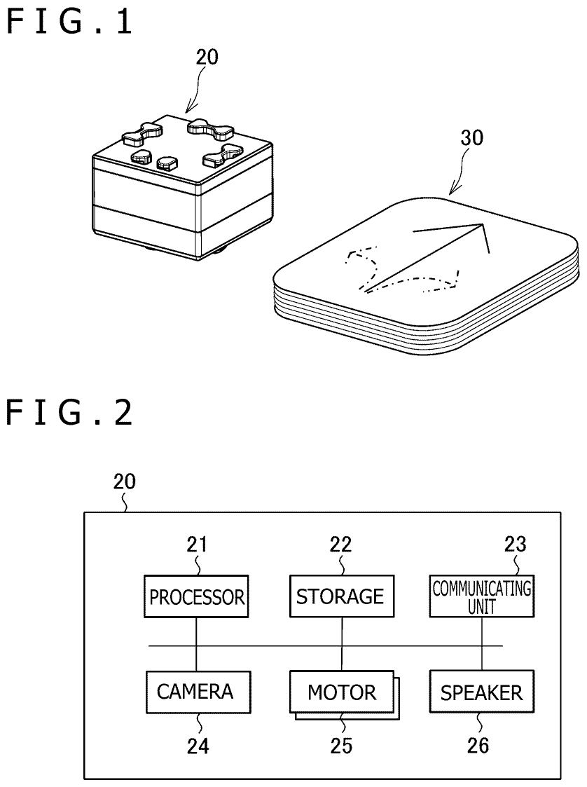

FIG. 1 is a view depicting an example of a toy system according to the embodiment of the present invention. The toy system according to the present invention includes at least a moving body 20 and a plurality of cards 30. The moving body 20 has a cubic external shape, whose corners are chamfered. In addition, an upper surface thereof is provided with a plurality of protrusions for enabling the attachment of another toy.

A user arranges at least a part of the plurality of cards 30 at any positions on a flat surface (on a desk or a floor, for example). When the moving body 20 travels on any one of the cards 30, the moving body 20 reads an image printed on the card 30 and performs an operation corresponding to an instruction indicated by the image.

The plurality of cards 30 are classified into a plurality of card types, and images in which information indicating the card types are coded are printed on the plurality of cards 30. The card types are further classified into groups in a plurality of layers. In a highest layer, the card types are classified into an operation instruction group and a setting group. Cards belonging to the operation instruction group will be referred to as operation instruction cards.

The plurality of cards 30 include a plurality of operation instruction cards. An image indicating an instruction for an operation of the moving body 20 (operation instruction) is printed on each of at least a part of the plurality of operation instruction cards. A coded image indicating any one of a plurality of operation instructions for the moving body 20 is printed on each of the plurality of operation instruction cards. Types of the operation instructions correspond to the card types on a one-to-one basis. Decoding of a card type corresponds to decoding of an operation instruction.

The operation instructions of the plurality of operation instruction cards are classified into a plurality of kinds (groups). The plurality of kinds include a state change type, an action type, and a forcing type. The state change type is a group including instructions for changing an operation (for example, a traveling state) of the moving body 20. The action type is a group mainly including instructions for making the moving body 20 perform a predetermined operation. In an instruction of the action type, a previous operation may be resumed after the operation is performed. Incidentally, also in the instruction of the action type, the traveling state may be changed as a result of the operation. The forcing type is a group including instructions for immediately stopping the moving body 20.

FIG. 2 is a view depicting an example of a hardware configuration of the toy system. The moving body 20 included in the toy system includes a processor 21, a storage 22, a communicating unit 23, a camera 24, two motors 25, and a speaker 26.

The processor 21 operates according to a program stored in the storage 22, and controls the communicating unit 23, the camera 24, the motors 25, the speaker 26, and the like. The above-described program may be supplied from another computer by communication via the communicating unit 23. The above-described program may be provided to the other computer in a state in which the program is stored on a computer readable storage medium such as a flash memory or an optical disk. The number of processors 21 may be one or may be plural.

The storage 22 is constituted by a dynamic random access memory (DRAM) and a nonvolatile memory or the like. The storage 22 stores the above-described program. In addition, the storage 22 stores information and arithmetic results input from the processor 21, the communicating unit 23, and the like.

The communicating unit 23 is constituted by a radio frequency circuit, an integrated circuit, an antenna, and the like for communicating with another apparatus. The communicating unit 23 has a function of communicating with another device (for example, a computer) according to a Bluetooth (registered trademark) protocol or a wireless local area network (LAN) protocol, for example. Under control of the processor 21, the communicating unit 23 inputs information received from the other device to the processor 21 or the storage 22 and transmits information to the other device. Incidentally, the communicating unit 23 may communicate with the other device via a wired network.

The camera 24 is disposed so as to image a position under the moving body 20. The camera 24 repeatedly images the position under the moving body 20. When the moving body 20 travels on a card 30, the camera 24 images patterns 71 (see FIG. 4) printed on the card 30. In the present embodiment, the patterns 71 recognized in an infrared frequency region are printed on the card 30. The camera 24 images an infrared image thereof. Incidentally, a picture recognized by visible light is printed on the card 30 in addition to the patterns 71.

The motors 25 are a generally-called servo motor that has a rotational direction, an amount of rotation, and a rotational speed thereof controlled by the processor 21.

The speaker 26 outputs sound under control of the processor 21 or the like.

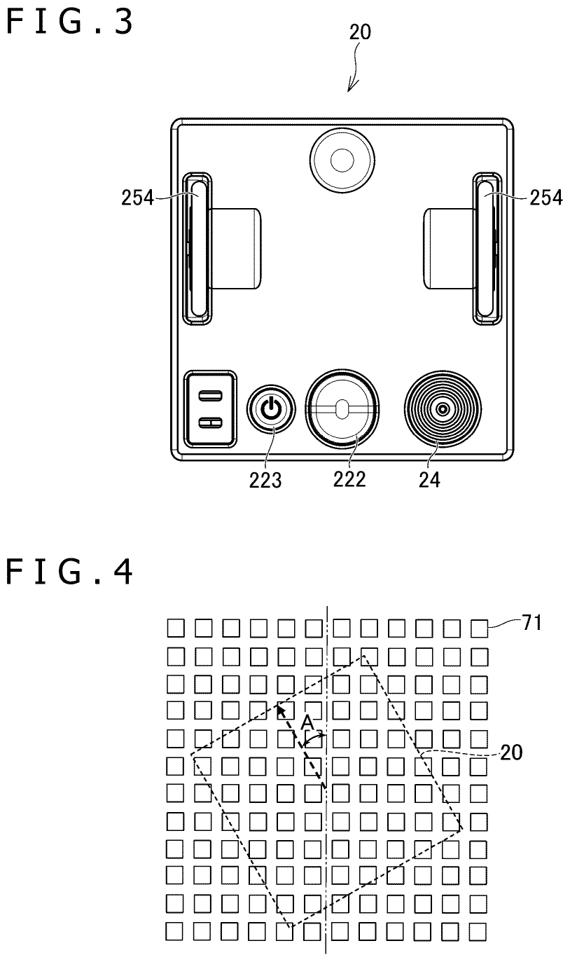

FIG. 3 is a view of an example of the moving body 20 as viewed from below. The moving body 20 further includes a switch 222, a power supply switch 223, and two wheels 254. One motor 25 is assigned to each of the two wheels 254. The motors 25 drive the assigned wheels 254. A driving mechanism including the motors 25 and the wheels 254 constitute a traveling device that makes the moving body 20 travel.

FIG. 4 is a view depicting an example of a relation between information printed on a card 30 and the moving body 20. A plurality of patterns 71 as images readable by the camera 24 are printed on the card 30 together with an image that is visible to the user. The patterns 71 having a predetermined size (for example, 0.2 mm square) are arranged in the form of a matrix on the card 30. The size of each of the patterns 71 is smaller than the sizes of the card 30 and the moving body 20. The information printed in the plurality of patterns 71 on a certain card 30 may be the same. A pattern 71 indicating a position within the card 30 may be printed on the certain card 30. Incidentally, when the moving body 20 passes on a card 30, patterns 71 printed at different positions are normally read as time progresses.

In the toy system according to the present embodiment, the camera 24 of the moving body 20 images a pattern 71 printed on the card 30, and the moving body 20 obtains information by decoding the pattern 71. In the following, this information will be described also as an operation instruction. The moving body 20 thereby recognizes the type of the card 30. In addition, the moving body 20 detects a direction (for example, an angle A from a reference direction) of the moving body 20 by detecting an inclination of the pattern 71 present within the image imaged by the camera 24.

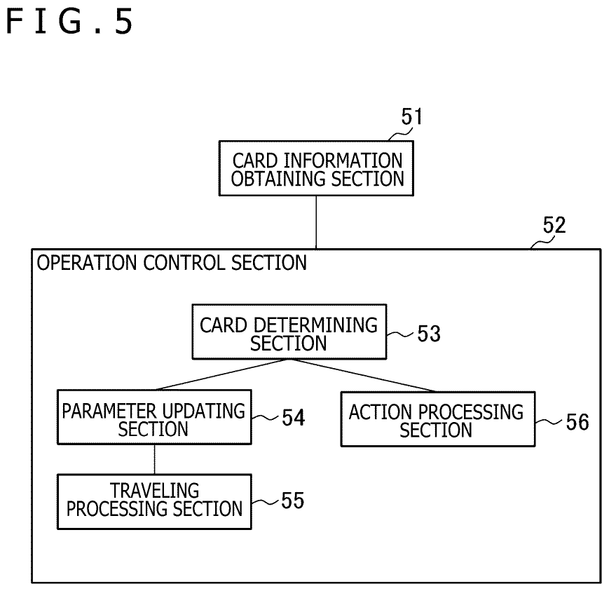

FIG. 5 is a block diagram depicting functions implemented by the toy system. The toy system functionally has a card information obtaining section 51 and an operation control section 52. The operation control section 52 functionally includes a card determining section 53, a parameter updating section 54, a traveling processing section 55, and an action processing section 56. These functions are mainly implemented by the processor 21 included in the moving body 20 by executing the program stored in the storage 22 and thereby controlling the camera 24, the motors 25, and the speaker 26. Incidentally, a part of these functions may be implemented by the processor 21 by transmitting a processing request to another computer included in the toy system via the communicating unit 23, and receiving a result of processing from the other computer.

The card information obtaining section 51 reads the pattern 71 (image) printed on the card 30, and obtains information indicated by the pattern 71. The card information obtaining section 51 obtains an operation instruction for the moving body 20 on the basis of the pattern 71 printed on the card 30 as an operation instruction card. More specifically, when the moving body 20 travels on any one of the plurality of cards 30, the card information obtaining section 51 reads a pattern 71 printed on the card 30, and decodes information (for example, an operation instruction) from the pattern 71. In addition, the card information obtaining section 51 obtains an orientation of the moving body 20 with respect to the card 30 on the basis of the inclination of the pattern 71 imaged by the camera 24.

The operation control section 52 controls the traveling device, the speaker 26, or the like according to the obtained operation instruction. In a case where the operation instruction is information indicating a change in a traveling state, the operation control section 52 controls the traveling device (motors 25) according to the information after the obtainment of the pattern 71 from which the information is obtained. More specifically, in a case where the operation instruction belongs to the group of the state change type, the operation control section 52 changes a traveling parameter according to the operation instruction, and controls the traveling device (motors 25) according to the changed parameter. In addition, in a case where no coded pattern 71 is read, the operation control section 52 controls the traveling device so as to continue an operation corresponding to an operation instruction indicated by a previously read pattern 71 until the moving body 20 reads a new coded pattern 71 by traveling on a new card 30 among the plurality of cards 30. When the new coded pattern 71 is read, the operation control section 52 controls the traveling device according to a new operation instruction indicated by the new pattern 71.

The card determining section 53 determines a group to which the operation instruction of the card 30 obtained by the processing of the card information obtaining section 51 belongs. Then, when the operation instruction belongs to the state change type, the card determining section 53 makes processing of the parameter updating section 54 performed. When the operation instruction belongs to the action type, on the other hand, processing of the action processing section 56 is made to be performed.

The parameter updating section 54 updates a traveling parameter on the basis of the operation instruction belonging to the state change type. Here, operation instructions belonging to the state change type are further classified into a plurality of sub-groups. The plurality of sub-groups include a steering sub-group, a speed sub-group, and a brake sub-group. There is a traveling parameter for each of the sub-groups. The steering sub-group includes an instruction for making a steering state right or left and an instruction for making the steering state straight forward. Making the steering state right or left means that the traveling direction of the moving body 20 is continuously changed to a right or a left, and a value corresponding to the instruction is set as a traveling parameter of steering. The speed sub-group includes an instruction for setting a traveling parameter of speed to a specified value. The specified value may be one of a plurality of candidate values determined in advance (for example, slow, fast, and very fast). A plurality of instructions included in the speed sub-group may respectively indicate candidate values different from each other. The brake sub-group includes a brake instruction for continuously decreasing speed. A traveling parameter of a brake state is set according to the brake instruction. According to the traveling parameter, the moving body 20 performs an operation of a brake that continuously decreases speed. Here, each of the plurality of operation instructions belonging to the state change type may be classified (labeled) into one or a plurality of sub-groups. For example, a certain operation instruction may be labeled as both that of the speed sub-group and that of the steering sub-group.

The parameter updating section 54 updates the traveling parameter of a sub-group into which the operation instruction indicated by the read pattern 71 is classified among the plurality of sub-groups to information (for example, a value) indicated by the operation instruction. The operation of the moving body 20 can be made more diverse by setting a traveling parameter for each sub-group and controlling traveling by the plurality of traveling parameters. When the operation instruction indicated by the read pattern 71 is classified into a plurality of sub-groups of the state change type, the parameter updating section 54 may update the respective traveling parameters of the plurality of sub-groups to which the operation instruction belongs to information of the traveling parameters of the respective sub-groups corresponding to the operation instruction.

The traveling processing section 55 controls the traveling device (for example, the motors 25) on the basis of an operation instruction (for example, a traveling parameter) set in each of the plurality of sub-groups. The traveling processing section 55 makes the moving body 20 travel at a speed corresponding to the parameter of the speed sub-group. In addition, when the parameter of the brake state is set, the traveling processing section 55 continuously decreases the speed of the moving body 20 so as to stop at a braking distance corresponding to the speed at a time of the setting. The traveling processing section 55 controls the traveling device such that the moving body 20 travels according to the traveling parameter. The traveling processing section 55 continuously changes the traveling direction of the moving body 20 to the right or the left or makes the moving body 20 move straight forward according to the traveling parameter of the steering state. After an image indicating a steering instruction for changing the traveling direction to the right or the left is read, the traveling processing section 55 controls the traveling device so as to change the traveling direction to the right or the left with a turning radius corresponding to a present speed of the moving body 20. More specifically, when an instruction for making the steering state right or left is set as the traveling parameter of the steering sub-group, the traveling processing section 55 controls the traveling device so as to change the traveling direction to the right or the left with the turning radius corresponding to the present speed of the moving body 20.

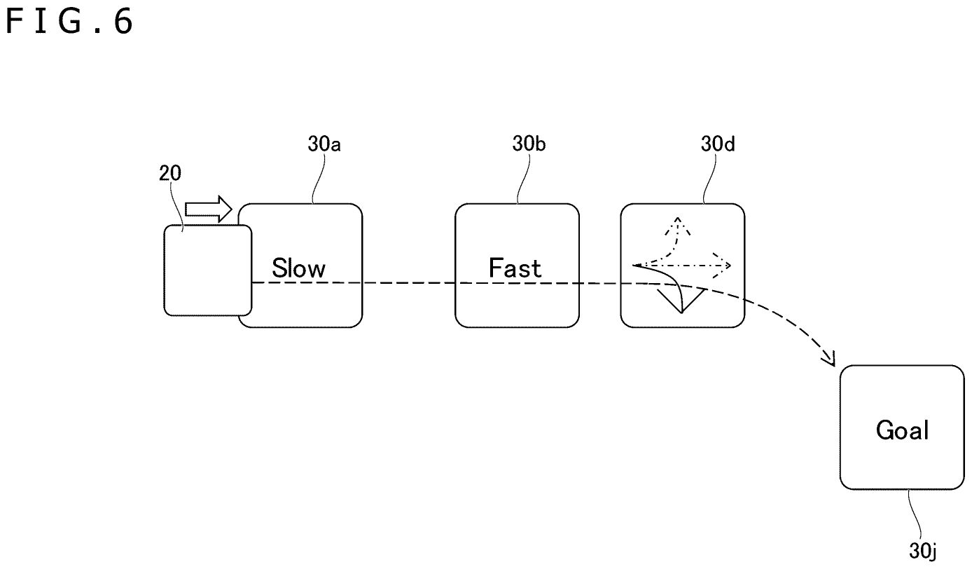

Here, a description will be made of a concrete example of traveling of the moving body 20 according to changes in the traveling parameters. FIG. 6 is a view of assistance in explaining an example of control of the moving body 20 by cards 30 (operation instruction cards in this case). In the example of FIG. 6, the following cards are arranged: a “Slow” card 30a, a “Fast” card 30b, a right direction card 30d, and a goal card 30j. In the example of FIG. 6, the moving body 20 first reads a pattern 71 on the card 30a, sets the parameter of the speed sub-group to a first speed, and moves straight forward at the speed. Next, the moving body 20 reads a pattern 71 on the card 30b, updates the parameter of the speed sub-group to a second speed faster than the first speed, and moves straight forward at the speed. Next, the moving body 20 reads a pattern 71 on the card 30d, updates the parameter of the steering sub-group to “right,” and travels so as to turn right while maintaining the speed. Then, when the moving body 20 reaches the card 30j, the moving body 20, which reads a pattern 71 on the card 30j, produces a sound and stops.

Here, for example, patterns 71 indicating an operation instruction of a combination of “Fast” and a right direction may be printed on one card 30. In this case, there exists a card 30 such that the card 30b and the card 30d are integrated with each other. When the moving body 20 reads a pattern 71 on the card 30, the moving body 20 updates the parameter of the speed sub-group to the second speed and updates the traveling parameter of the steering sub-group to “right.” The moving body 20 may thereafter travel so as to turn right at the second speed. In addition, there may be cards 30 on which patterns 71 indicating operation instructions of combinations of other speeds and steering states are printed.

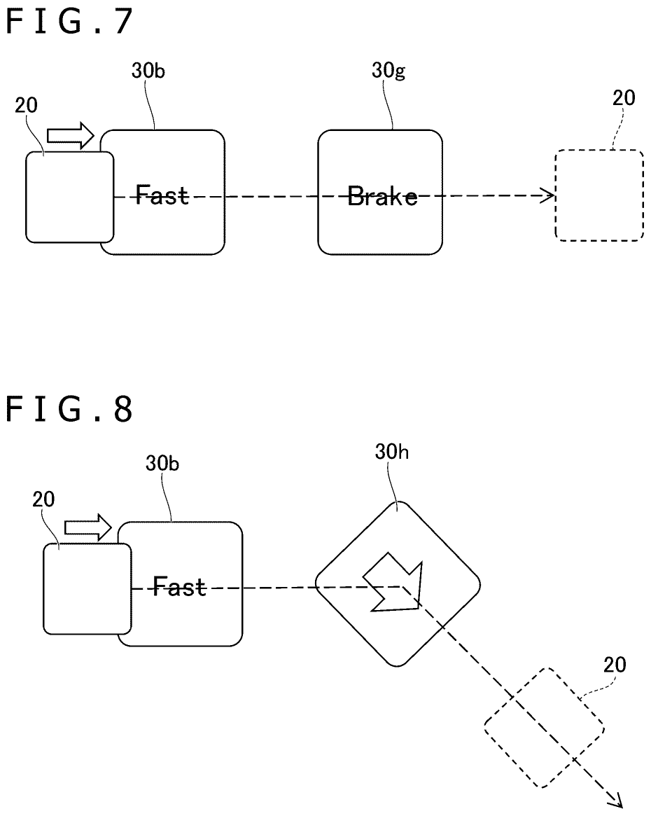

FIG. 7 is a view of assistance in explaining another example of control of the moving body 20 by cards 30 (operation instruction cards in this case). In the example of FIG. 7, a “Fast” card 30b and a “Brake” card 30g are arranged. In the example of FIG. 7, the moving body 20 first reads a pattern 71 on the card 30b, updates the parameter of the speed sub-group to the second speed, and moves straight forward at the speed. Then, a pattern 71 on the card 30g is read, and the parameter of the brake sub-group is updated to a brake state. Then, the moving body 20 continuously reduces the speed of the moving body 20 according to the parameter of the brake state. The speed of the moving body 20 ultimately becomes zero, and the moving body 20 stops.

The action processing section 56 controls the moving body 20 on the basis of an operation instruction belonging to the action type such that the moving body 20 performs an operation indicated by the operation instruction. When an instruction for turning to a direction specified by a card 30 is obtained, or in other words, when an instruction for setting the moving body 20 in a state of traveling in a specified direction is obtained, the action processing section 56 controls the traveling device such that the moving body 20 turns to the specified direction.

FIG. 8 is a view of assistance in explaining another example of control of the moving body 20 by cards 30 (operation instruction cards in this case). In the example of FIG. 8, a “Fast” card 30b and an arrow card 30h indicating a traveling direction are arranged as operation instruction cards. In the example of FIG. 8, the moving body 20 first reads a pattern 71 on the card 30b, updates the parameter of the speed sub-group to the second speed, and moves straight forward at the speed. The second speed is a specified (faster) speed. Then reading a pattern 71 on the card 30h, the moving body 20 performs an action of turning (changing direction) such that a direction indicated by the pattern 71 and the traveling direction of the moving body 20 are at a predetermined angle (the moving body 20 faces in the direction of the arrow in actuality). When ending the turning, the moving body 20 moves straight forward in the traveling direction at the second speed.

In the example of FIG. 8, the moving body 20 thus repeats changing, for example, a traveling parameter or a traveling state such as the traveling direction according to an operation instruction of a card 30, thereafter continuing an operation according to the operation instruction and moving until reaching a next card 30, and changing the traveling state according to an operation instruction. Consequently, the reading of the cards 30 and the resulting operations become interactive, and the user can experience more intuitive and easier programming. In addition, because there is no limitation of arranging the cards 30 without spaces therebetween, the user can place the cards 30 at any positions, so that a degree of freedom of the operation of the moving body 20 in programming experience is increased. In addition, by reproducing operations in a real world such as steering and braking in a pseudo manner, the toy system can foster a more advanced thinking ability while attracting the interest of the user. However, even when cards 30 are arranged without spaces therebetween, a configuration of an inner region 31 and a peripheral region 32 of a card 30 and control of the moving body 20 are effective. This will be described later.

In the example described thus far, there is no limitation of arranging cards 30 without spaces therebetween. In this case, the user can place cards 30 at any positions. Thus, a degree of freedom of the operation of the moving body 20 in programming experience is increased, and the user can be made to have an advanced experience. However, there may be a limitation on a method of arranging cards 30 according to the present embodiment. For example, a sheet having a plurality of recesses may be used, and a card 30 may be fitted to any one of the plurality of recesses. Alternatively, cards 30 may be arranged such that sides constituting the perimeters of the cards 30 are in contact with or adjacent to each other. In a case where cards 30 are arranged without spaces therebetween, a card 30 that does not change the operation of the moving body 20 may be included in the plurality of cards 30, and may be disposed between cards 30 indicating operation instructions.

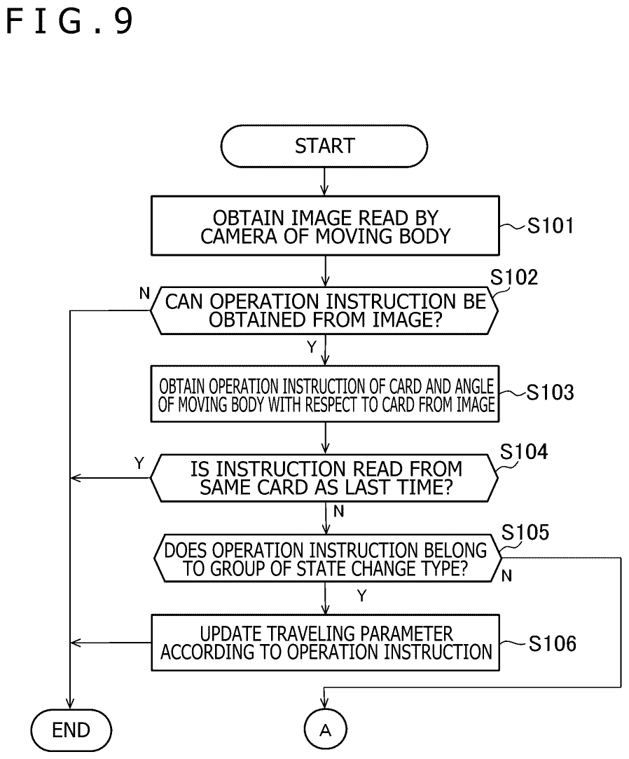

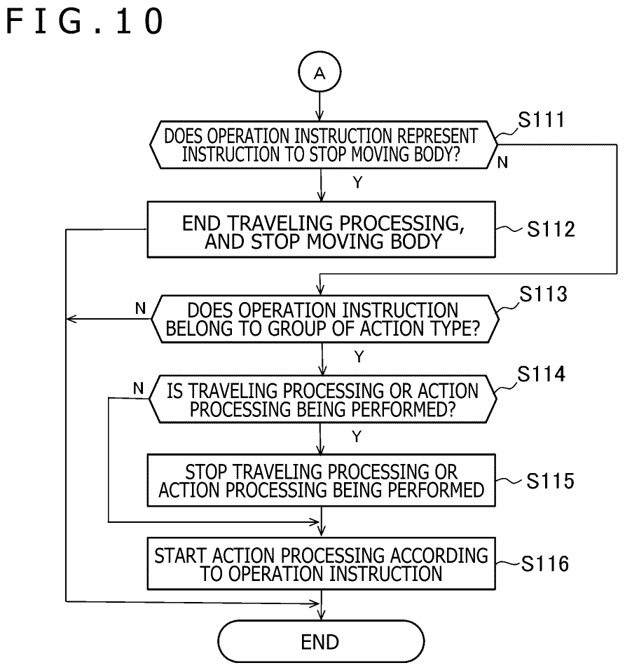

Processing for implementing the operation of the moving body 20 according to the present embodiment will next be described in more detail. FIGS. 9 and 10 are a flowchart depicting an example of the processing of the moving body 20. FIGS. 9 and 10 mainly depict processing on an operation instruction card. FIGS. 9 and 10 mainly depict processing of the card information obtaining section 51, the card determining section 53, and the parameter updating section 54. The processing depicted in FIGS. 9 and 10 is repeated periodically (for example, at intervals of 0.1 seconds).

First, the card information obtaining section 51 obtains an image read by the camera 24 of the moving body 20 (S101). The card information obtaining section 51 determines whether an operation instruction can be obtained from the obtained image (S102). More specifically, the card information obtaining section 51 determines whether there is a pattern 71 in the obtained image. When no operation instruction can be obtained (N in S102), the processing of FIGS. 9 and 10 is ended. When an operation instruction can be obtained (Y in S102), the card information obtaining section 51 obtains the operation instruction of the card 30 and the angle A of the moving body 20 with respect to the card 30 from the image (S103). Processing using the angle A will be described later.

After obtaining the operation instruction of the card 30, the card information obtaining section 51 determines whether the operation instruction is obtained from the same card 30 as last time (S104). When the instruction is obtained from the same card 30 (Y in S104), the processing of FIGS. 9 and 10 is ended. Whether or not the instruction is obtained from the same card 30 may be determined according to whether or not the same instruction is read at a time of the above-described reading. Here, when no information is read at a time of a previous reading, or the read information does not indicate any instruction, and the operation instruction is read this time, it is determined that the instruction is not read from the same card 30 as last time. This processing prevents the occurrence of a problem and a waste of processing resources due to repetition of the same processing.

When the obtained operation instruction is different from the operation instruction obtained last time (N in S104), the card determining section 53 determines whether the obtained operation instruction belongs to the group of the state change type (S105). When the obtained operation instruction belongs to the state change type (Y in S105), the parameter updating section 54 updates a traveling parameter according to the operation instruction (S106).

More specifically, the parameter updating section 54 updates the traveling parameter of a sub-group into which the operation instruction is classified to a value indicated by the operation instruction. When the operation instruction belongs to the speed sub-group, the parameter updating section 54 sets the speed parameter to a value corresponding to the operation instruction. When the operation instruction belongs to the steering sub-group, the parameter updating section 54 updates the steering state parameter to a value indicated by the operation instruction (for example, any one of the right, the left, and moving straight forward). When the operation instruction belongs to the brake sub-group, the parameter updating section 54 updates the brake parameter to a brake state (or a no-brake state).

When the operation instruction belongs to a plurality of sub-groups, the parameter updating section 54 updates the respective traveling parameters of the plurality of sub-groups to values indicated by the operation instruction. For example, when the operation instruction belongs to the speed sub-group and the steering sub-group, the parameter updating section 54 sets the speed parameter to a value corresponding to the operation instruction, and updates the steering state parameter to a value indicated by the operation instruction. In this case, there may be a plurality of operation instructions in one-to-one correspondence with respective combinations of candidate values of the speed parameter (for example, slow, fast, and very fast) and candidate values of the steering state parameter (for example, right, left, and moving straight forward). There may be cards 30 in one-to-one correspondence with the plurality of operation instructions, respectively.

When the obtained operation instruction does not belong to the state change type (N in S105), on the other hand, the card determining section 53 determines whether the obtained operation instruction represents an instruction to stop the moving body 20 (S111). When the operation instruction represents an instruction to stop the moving body 20 (Y in S111), the traveling processing section 55 ends traveling processing, and stops the moving body 20 (S112).

When the operation instruction does not represent an instruction to stop the moving body 20 (N in S111), on the other hand, the card determining section 53 determines whether the obtained operation instruction belongs to the group of the action type (S113). When the operation instruction does not belong to the group of the action type (N in S113), the processing of FIGS. 9 and 10 is ended. When the operation instruction belongs to the group of the action type (Y in S113), the card determining section 53 determines whether the traveling processing of the traveling processing section 55 or the action processing of the action processing section 56 is currently being performed (S114). When the traveling processing or the action processing is being performed (Y in S114), the traveling processing or the action processing being performed is stopped (S115). When neither the traveling processing nor the action processing is being performed (N in S114), the processing of S115 is skipped. Then, the action processing section 56 starts action processing according to the operation instruction (S116).

For example, when an instruction to turn to a direction specified by the card 30 (for example, the direction of an arrow depicted on the card 30) is obtained, the action processing section 56 determines rotational directions and rotation amounts of the left and right motors 25 on the basis of the angle read from the card 30 in S103 in FIG. 9, and controls the motors 25 on the basis of the determination. The rotational directions and the rotation amounts are determined such that the orientation of the moving body 20 after rotation is a predetermined direction with respect to the card 30 (for example, the direction of the arrow of the card 30h). Details of this processing will be described later.

In another operation instruction belonging to a sub-group of the action type, the action processing section 56 may effect a fixed form of operation such as meandering traveling or spinning, by reproducing time-series motor control information stored in the storage 22.

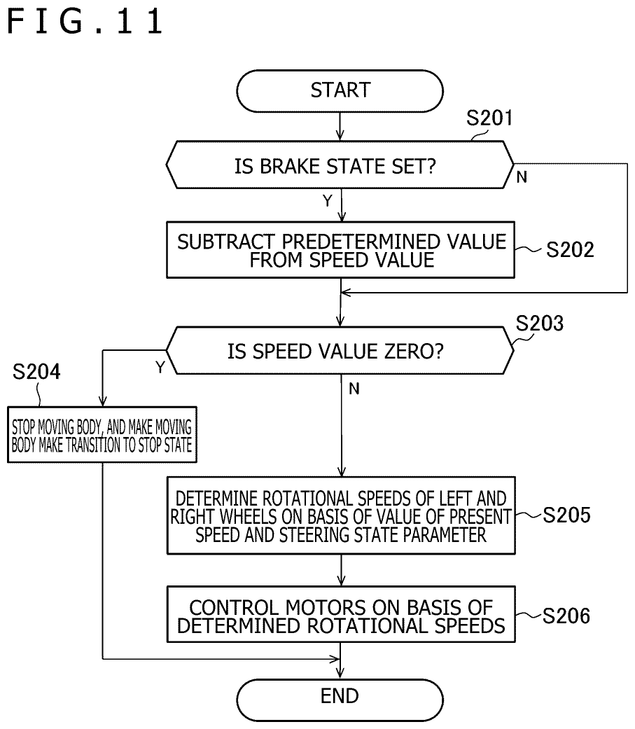

Details of the traveling processing by the traveling processing section 55 will next be described. FIG. 11 is a flowchart depicting an example of the traveling processing by the traveling processing section 55. The processing depicted in FIG. 11 is periodically performed except in a stop state or except when the action processing is being performed.

First, the traveling processing section 55 determines whether a brake state is set among the traveling parameters (S201). When the brake state is set (Y in S201), a predetermined value is subtracted from a speed value stored as the traveling parameter (S202). When the brake state is not set (N in S201), on the other hand, S202 is skipped.

Here, when the speed value is zero (Y in S203), the traveling processing section 55 makes the moving body 20 stop traveling, and makes the state of the moving body 20 make a transition to a stop state (S204).

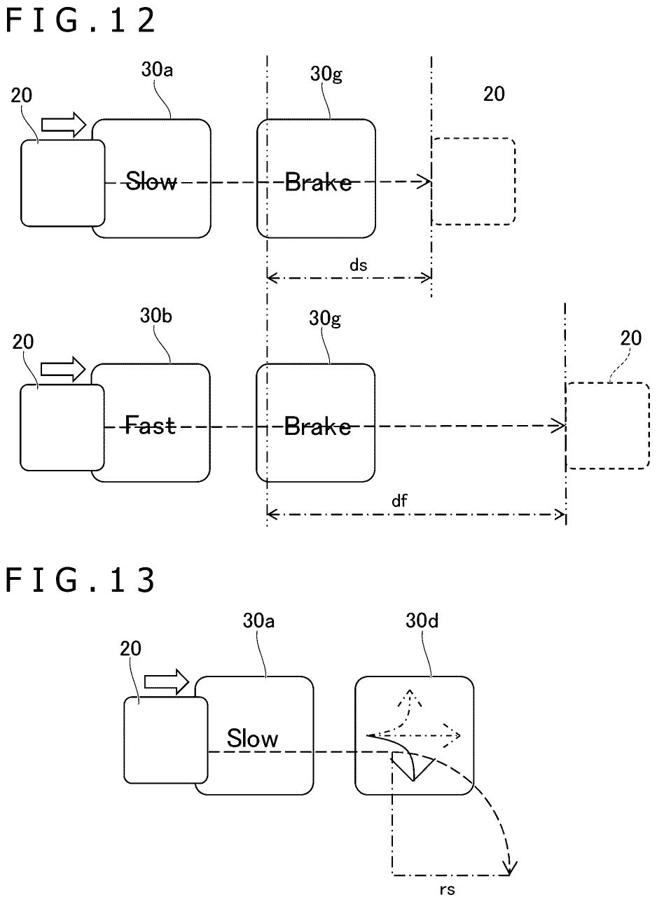

FIG. 12 is a view of assistance in explaining an example of a difference in the operation of the moving body 20 according to the speed. In an example on an upper side of FIG. 12, a “Slow” card 30a and a “Brake” card 30g are arranged. In an example on a lower side of FIG. 12, a “Fast” card 30b and a “Brake” card 30g are arranged. In the example on the upper side, the moving body 20 first reads a pattern 71 on the card 30a, updates the parameter of the speed sub-group to the first speed, and moves straight forward at the speed. Then, the moving body 20 reads a pattern 71 on the card 30g and updates the parameter of the brake sub-group to the brake state. Then, the moving body 20 stops after traveling until the speed becomes zero (by a braking distance ds) while continuously reducing the speed of the moving body 20 according to the brake state parameter. On the other hand, in the example on the lower side, the moving body 20 first reads a pattern 71 on the card 30b, updates the parameter of the speed sub-group to the second speed faster than the first speed, and moves straight forward at the speed. The moving body 20 reads a pattern 71 on the card 30g and updates the parameter of the brake sub-group to the brake state. The moving body 20 thereafter stops after traveling by a braking distance df while reducing the speed.

In the processing of FIG. 11, when the brake state is set, the reduction of the speed by a certain amount is periodically performed. Therefore, the faster the speed, the longer a time taken for the speed to become zero, and the higher an average speed during traveling. Thus, the faster the speed, the larger the braking distance. This is similar to uniformly accelerated motion with an acceleration opposite from the traveling direction. The motors 25 of the moving body 20 are servo motors, and it is easy to abruptly stop the rotation thereof irrespective of the speed. Here, motion close to physical motion is achieved by controlling the motors 25 so as to attain the braking distances ds and df corresponding to the speeds. Effects of programming experience are thereby improved.

A continuation of the processing will be described in the following. When the value of the speed is not zero in S203 (N in S203), the traveling processing section 55 determines rotational speeds of the left and right wheels 254 on the basis of the value of the present speed and the steering state parameter (S205). The traveling processing section 55 controls the rotations of the left and right motors 25 on the basis of the determined rotational speeds (S206).

Because the two wheels 254 in the present embodiment are driven by the motors 25 different from each other, the moving body 20 can be made to move straight forward, continuously turn to the right, or continuously turn to the left by controlling the rotational speeds of the wheels 254 (motors 25). In the case of moving straight forward, a difference between the left and right rotational speeds is substantially zero.

Here, in S205, when the steering state parameter is set to the right or the left, the traveling processing section 55 determines the rotational speeds of the left and right wheels 254 such that the higher the speed parameter among the traveling parameters, the larger the turning radius (the turning radius corresponds to the curvature of a trajectory). For example, the traveling processing section 55 may determine the rotational speeds of the left and right wheels 254 such that the difference between the rotational speeds of the left and right wheels 254 is constant and such that a sum of the rotational speeds of the left and right wheels 254 is proportional to the speed parameter. In this case, the turning radius is substantially proportional to the speed. The rotational speeds may be calculated by another equation, or the traveling processing section 55 may determine the rotational speeds by referring to a table that stores the rotational speeds of the left and right wheels 254 for each speed.

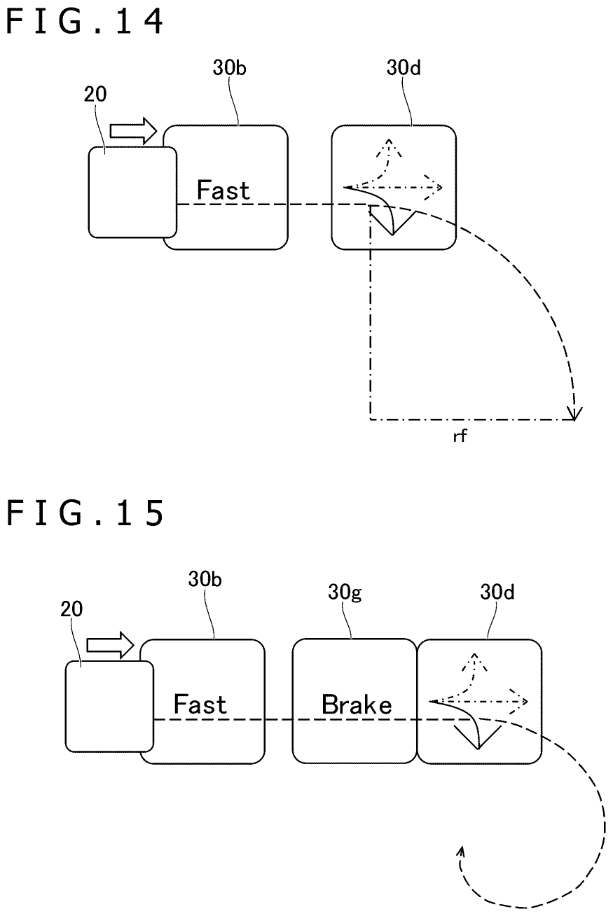

FIGS. 13 and 14 are views of assistance in explaining another example of a difference in the operation of the moving body 20 according to the speed. In the example of FIG. 13, the moving body 20 first reads a pattern 71 on the “Slow” card 30a, changes the speed of the moving body 20 itself to the first speed, thereafter reads a pattern 71 on a right direction card 30d, updates the steering state parameter to the “right,” and travels so as to turn to the right while maintaining the speed. At this time, the moving body 20 turns in a right direction with a turning radius rs.

In the example of FIG. 14, on the other hand, the moving body 20 first reads a pattern 71 on the “Fast” card 30b, changes the speed of the moving body 20 itself to the faster second speed, thereafter reads a pattern 71 on the card 30d, and turns in the right direction with a turning radius df. The turning radius df is larger than the turning radius ds.

In a programming teaching material, in the past, in which cards are arranged, an area on which a device such as the moving body 20 travels is in a grid form. In addition, because consideration is not given to the device operating while ignoring the grid, the device is made to change direction on cards in units of 90 degrees instead of a change in direction such as steering.

On the other hand, in the example of FIGS. 13 and 14, a condition that the turning radius is increased as the speed becomes faster at a time of turning to the right or the left as in a steering operation is further added. Then, the operation of the moving body 20 is diversified, and room for contrivance at a time that the user arranges cards 30 is increased. In addition, the condition is similar to the behavior of an actual vehicle or the like, and is thus easy for the user to understand intuitively. It is therefore possible to provide a more advanced programming experience while attracting the interest of the user. Incidentally, in the case of the moving body 20 used as a toy, this condition cannot be realized unless the rotational speeds are controlled intentionally. The traveling processing section 55 therefore simulates this phenomenon in a pseudo manner by intentionally controlling the left and right rotational speeds.

In addition, a more interesting experience is also provided when the brake state or the like is combined. FIG. 15 is a view of assistance in explaining another example of a difference in the operation of the moving body according to the speed. In the example of FIG. 15, a pattern 71 on the “Fast” card 30b is first read, the speed of the moving body 20 becomes the second speed, a pattern 71 on the “Brake” card 30g is read, and a pattern 71 on the card 30d is read in a process in which the speed is continuously decreased. The moving body 20 turns in the right direction while decreasing the speed. At this time, the moving body 20 turns in the right direction such that the turning radius monotonically decreases according to the speed. The simple control enables spiral movement and thereby provides a more advanced experience to the user.

Incidentally, in a case where the moving body 20 includes a steering mechanism, the traveling processing section 55 may perform control that moves the moving body 20 straight forward, turns the moving body 20 to the right, or turns the moving body 20 to the left by setting the orientation of a part of the wheels 254.

By the processing depicted in FIGS. 9 to 11, the moving body 20 travels according to the traveling parameter set by a card 30. In addition, even when the moving body 20 moves away from the card 30, the operation control section 52 controls the traveling device so as to continue an operation corresponding to an operation instruction indicated by a previously read pattern 71 until the moving body 20 reads a new pattern 71 by traveling on a new card 30.

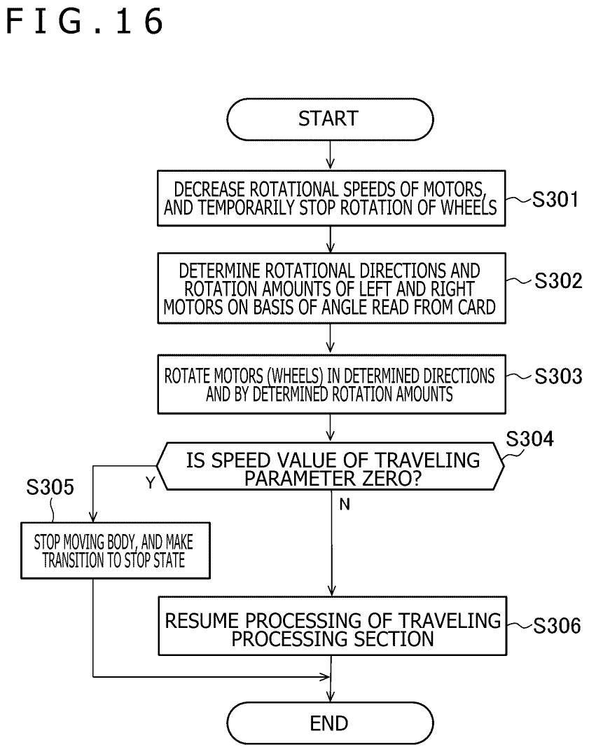

FIG. 16 is a flowchart depicting an example of the action processing by the action processing section 56. FIG. 16 depicts processing performed according to an operation instruction for turning the traveling direction to a specified direction such as that of the card 30h in particular among a plurality of operation instructions of the action type. The processing depicted in FIG. 16 is started by S116 in FIG. 10.

First, the action processing section 56 decreases the rotational speeds of the two motors 25 and temporarily stops the rotation of the wheels 254 (S301). Next, rotational directions and rotation amounts of the left and right motors 25 are determined on the basis of the angle read from the card 30 in S103 in FIG. 9 (S302). The rotational directions and the rotation amounts are determined such that the orientation of the moving body 20 after rotation is a predetermined direction with respect to the card 30 (for example, the direction of the arrow of the card 30h). In addition, the action processing section 56 determines the rotational directions and the rotation amounts such that the rotational directions of the left and right wheels 254 are opposite from each other and such that the moving body 20 is oriented in the predetermined direction by minimum rotations.

Here, when the value of the speed of the traveling parameter is zero (Y in S304), the action processing section 56 stops the moving body 20, and makes the state of the moving body 20 make a transition to a stop state (S305). When the value of the speed of the traveling parameter is not zero (N in S304), the action processing section 56 resumes the traveling processing of the traveling processing section 55 (S306). The processing of FIG. 16 is then ended.

In this processing, the traveling direction is physically changed by the action set by the card 30. In addition, after the action, the traveling processing is resumed, and thereby the moving body 20 travels according to the traveling parameter set before the action. From the above, the traveling device can be controlled so as to continue an operation corresponding to a previous operation instruction until the moving body 20 reads a new pattern 71 by traveling on a new card 30.

The processing performed by the action processing section 56 is not limited to the above. For example, in another operation instruction belonging to a sub-group of the action type, a fixed form of operation such as meandering traveling or spinning (rotation) may be performed by reproducing time-series motor control information stored in the storage 22 instead of the processing depicted in S301 to S303. In addition, in another operation instruction, instead of the processing depicted in S301 to S303, processing of reproducing sound stored in the storage 22 in advance from the speaker 26 may be performed.

### Example of Method for Directing Whether or Not Instruction is Obtained From Same Card 30

An example of a method for detecting whether or not an instruction is obtained from the same card 30, as described in S104 in FIG. 9, will next be described in more detail.

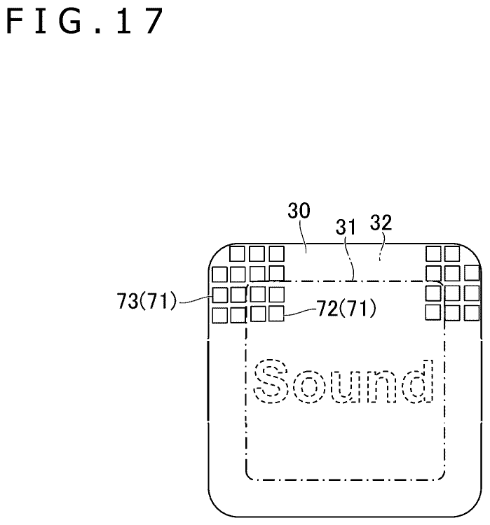

FIG. 17 is a view of assistance in explaining an example of a card 30. The top surface of the single card 30 includes an inner region 31 enclosed by alternate long and short dashed lines in FIG. 17 and a peripheral region 32 located outside the alternate long and short dashed lines and surrounding the inner region 31. A plurality of patterns 71 are printed on the card 30 so as to be arranged in a matrix form. Each of the patterns 71 is an image of a predetermined size 0.2 mm square, for example. The size of each of the patterns 71 is smaller than the size of the moving body 20. While the patterns 71 are depicted on a part of the card 30 in FIG. 17, the patterns 71 are actually arranged so as to fill the card 30. In order to facilitate the description, an image “Sound” that can be recognized by visible light is depicted by a broken line.

Among the patterns 71, a plurality of identification patterns 72 indicating a card type to which the card 30 belongs are arranged in the inner region 31. The identification patterns 72 are images in which information of the card type is coded. The images of the identification patterns 72 differ according to the card type. The plurality of identification patterns 72 are disposed within the inner region 31 so as to be arranged in a matrix form. The plurality of identification patterns 72 may be the same image in the same card 30. Incidentally, the inner region 31 may not be in a rectangular shape, and patterns 71 lying off the inner region 31 are not identification patterns 72 but peripheral patterns 73 to be described later. In addition, the identification patterns 72 whose number is, for example, 3×3 or more are arranged within the inner region 31 such that the moving body 20 traveling within the inner region 31 can surely recognize an identification pattern 72. The identification patterns 72 do not necessarily need to be arranged in a matrix form, but may be arranged concentrically, for example.

The peripheral region 32 is disposed at a peripheral edge of the top surface of the card 30. A plurality of peripheral patterns 73 are arranged in the peripheral region 32 so as to surround the inner region 31 in which the plurality of identification patterns 72 are arranged. From a different viewpoint, the identification patterns 72 indicating any one of the card types are not printed in the peripheral region 32. The peripheral patterns 73 are patterns 71 not indicating any of the plurality of card types, and are images in which peripheral information different from the information indicating the card types is coded. The peripheral information in the present embodiment is a fixed value regardless of the card type. However, the peripheral information does not necessarily need to be a fixed value. It suffices for the plurality of peripheral patterns 73 to be arranged so as to be surely read by the moving body 20 traveling from the inner region 31 to the outside of the card 30, and the plurality of peripheral patterns 73 do not necessarily need to be arranged in a matrix form. The width of the peripheral region 32 may be equal to or more than twice the size of the patterns 71, for example.

Incidentally, the alternate long and short dashed lines are not actually printed. However, it is obvious that a boundary between the inner region 31 and the peripheral region 32 is present between identification patterns 72 and peripheral patterns 73 adjacent to each other, and the presence of the inner region 31 and the peripheral region 32 can be recognized easily. No patterns 71 may be printed in the peripheral region 32.

As described with reference to FIG. 4, when the moving body 20 passes on the card 30, patterns 71 printed at different positions are normally read as time progresses.

In the toy system according to the present embodiment, the camera 24 of the moving body 20 images a pattern 71 printed on the card 30, and the moving body 20 obtains information by decoding the pattern 71. For example, the moving body 20 obtains, from an identification pattern 72 printed on an operation instruction card, an operation instruction as information of the identification pattern 72. The moving body 20 obtains peripheral information from a peripheral pattern 73.

A configuration of functions implemented by the toy system is depicted in FIG. 5. In the following, the functions will be supplemented. A description of what has been described thus far will be omitted.

When the moving body 20 travels on any one of a plurality of cards 30, the card information obtaining section 51 reads patterns 71 printed on the card 30, and decodes information (a card type and peripheral information) from the patterns 71. Here, the card type is decoded from an identification pattern 72, and the peripheral information is decoded from a peripheral pattern 73.

When information indicating an operation instruction (card type) is obtained from the identification pattern 72, the operation control section 52 controls the traveling device, the speaker 26, or the like according to the operation instruction. When no identification pattern 72 is read, the operation control section 52 controls the traveling device so as to continue an operation corresponding to a previously read operation instruction until the moving body 20 reads a new identification pattern 72 by traveling on a new card 30. When an operation instruction is obtained from the new identification pattern 72, the operation control section 52 controls the operation of the moving body 20 according to the new operation instruction indicated by the new identification pattern 72.

In addition, in a case where the camera 24 images the identification pattern 72 after imaging the peripheral pattern 73, the operation control section 52 controls the traveling device of the moving body 20 on the basis of the imaged identification pattern 72. In a case where the camera 24 images the same identification pattern 72 as last time, on the other hand, the operation control section 52 does not control the operation of the moving body 20 on the basis of the imaged identification pattern 72. Incidentally, in a case where the identification pattern 72 is imaged for the first time when the moving body 20 starts traveling on the basis of an instruction of the user, the operation control section 52 may control the traveling device of the moving body 20 on the basis of the imaged identification pattern 72. When a plurality of cards 30 of the same type are arranged, the above-described processing enables a difference between the cards 30 to be recognized.

The card determining section 53 determines whether information obtained by the processing of the card information obtaining section 51 is the card type or the peripheral information, and further determines to which of the operation instruction group and the setting group the card type belongs. In addition, when the card type belongs to the operation instruction group, or in other words, when the information indicates an operation instruction, the card determining section 53 determines a group to which the operation instruction belongs. Then, the card determining section 53 makes the processing of the parameter updating section 54 performed when the operation instruction belongs to the state change type, and the card determining section 53 makes the processing of the action processing section 56 performed when the operation instruction belongs to the action type.

When an instruction to turn to a specified direction is obtained from the identification pattern 72, the action processing section 56 controls the traveling device such that the moving body 20 turns to the specified direction. When an instruction to perform a predetermined operation is obtained as the operation instruction belonging to the action type from the identification pattern 72, the action processing section 56 performs control such that the moving body 20 performs the predetermined operation. The instruction to perform the predetermined operation may be, for example, an instruction to output a predetermined sound or perform a predetermined traveling (meandering or rotation).

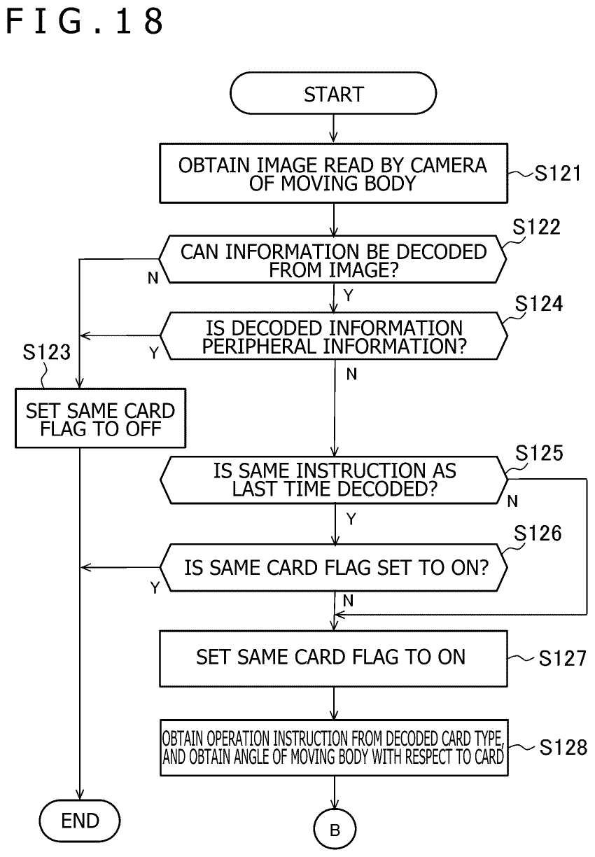

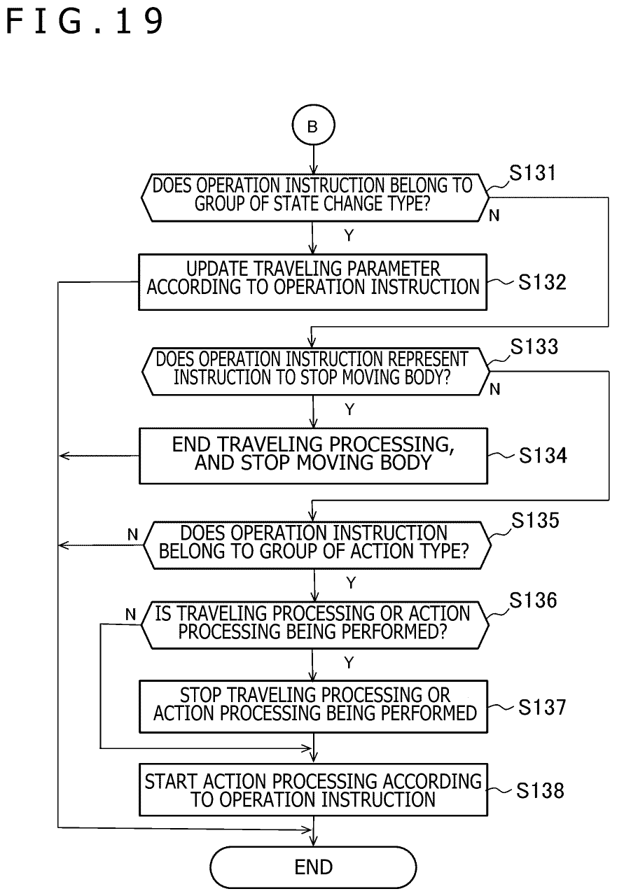

A description will next be made of an effect of providing the inner region 31 and the peripheral region 32 of the card 30 while making a more detailed description of processing for implementing the operation described with reference to FIG. 8 and the like. FIGS. 18 and 19 are a flowchart depicting an example of processing of the moving body 20. FIGS. 18 and 19 mainly depict processing of the card information obtaining section 51, the card determining section 53, and the parameter updating section 54. The processing depicted in FIGS. 18 and 19 is repeated periodically (for example, at intervals of 0.1 seconds). While an operation such as takes a certain time is performed according to an operation instruction of the action type, only processing for determining whether the card type is read from the same card 30 (S121 to S127) may be performed periodically. Even when a movement is made to another card 30 of the same kind during the operation of an action, information can be obtained accurately from a card 30 read at a time of an end of the action.

First, the card information obtaining section 51 obtains an image read by the camera 24 of the moving body 20 (S121). The card information obtaining section 51 determines whether information can be decoded from the obtained image (S122). This processing is processing of determining whether there are patterns 71 in the obtained image. When the information cannot be decoded (N in S122), the card information obtaining section 51 sets the same card flag to OFF. The processing depicted in FIGS. 18 and 19 is then ended. When the information can be decoded (Y in S122), on the other hand, the card information obtaining section 51 determines whether the decoded information is peripheral information (S124). Here, this determination may be made according to whether or not the decoded information is within a range of values indicating the card type. When the decoded information is peripheral information (Y in S124), the card information obtaining section 51 sets the same card flag to OFF. The processing depicted in FIGS. 18 and 19 is then ended. When the decoded information is not peripheral information (N in S124), on the other hand, the card information obtaining section 51 checks whether the same instruction as last time is decoded (S125). When the same instruction as last time is not decoded (N in S125), S126 is skipped, and processing from S127 on down is performed. When the same instruction as last time is decoded (Y in S125), whether the same card flag is set to ON is determined (S126).

When the same card flag is set to ON (Y in S126), the card information obtaining section 51 ends the processing depicted in FIGS. 18 and 19. When the same card flag is set to OFF (N in S126), on the other hand, the card information obtaining section 51 sets the same card flag to ON (S127). In addition, the card information obtaining section 51 obtains an instruction (operation instruction in this case) from the decoded card type, and obtains the angle A of the moving body 20 with respect to the card 30 (S128). Then, processing from S131 on down (processing of controlling the traveling device, the speaker 26, or the like) is performed to make the moving body 20 operate according to the instruction.

When the processing from S122 to S124 and from S126 to S128 detects whether or not the card type information is obtained from the same card 30 as last time, and the card type information is obtained from the same card 30, control based on the instruction indicated by the card type is not newly performed. In addition, when these pieces of processing obtain the card type information from a new card 30, control based on the instruction indicated by the card type is newly performed. The processing of S125 is processing for dealing with a case where the moving body 20 is moved by hand, and the identification patterns 72 of two cards 30 of different types are forcedly read.

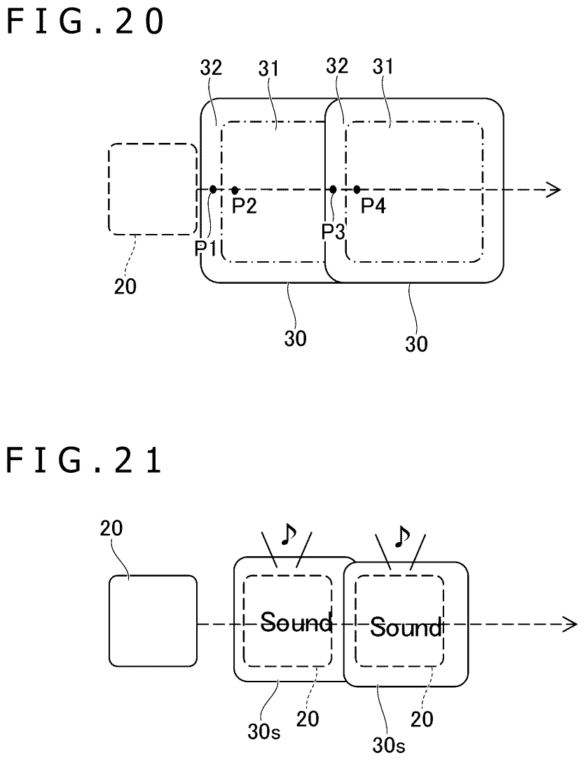

FIG. 20 is a view depicting an example of a plurality of arranged cards 30. In the example of FIG. 20, two cards 30 are arranged so as to partly overlap each other. In addition, the moving body 20 moves from the left to the right in FIG. 20, and reads patterns 71 from the two cards. The inner region 31 and the peripheral region 32 are present in each of the cards 30. However, at a boundary between the two cards 30, the peripheral region 32 of the left card 30 is hidden under the right card 30.

In the example of FIG. 20, before the camera 24 of the moving body 20 reads images of the cards 30, the card information obtaining section 51 cannot decode information, and sets the same card flag to OFF. In addition, when the camera 24 images a peripheral pattern 73 located at a position P1, peripheral information is decoded, and the same card flag remains OFF. When the camera 24 images an identification pattern 72 located at a position P2 in this state, because the same card flag is set to OFF, processing of controlling the operation of the moving body 20 according to the decoded card type is performed, and the same card flag is set to ON. On the other hand, even when an identification pattern 72 is thereafter imaged in the inner region 31 of the left card 30, the processing of controlling the operation of the moving body 20 is not performed because the same card flag is set to ON.

When the camera 24 thereafter images a peripheral pattern 72 at a position P3, peripheral information is decoded, and the same card flag is set to OFF. It is thereby determined that an identification pattern 72 to be read next is information to be read from the new card 30. When the camera 24 thereafter images an identification pattern 72 at a position P4, the processing of controlling the operation of the moving body 20 according to a decoded card type is performed.

If the peripheral region 32 in which the peripheral patterns 73 are printed does not exist, and the identification patterns 72 of the same card type are printed on the entire surfaces of the two cards 30, even when a pattern 71 of the second card 30 is read, the same information as that of the preceding card 30 is decoded. It is therefore difficult for the moving body 20 to recognize whether an identification pattern 72 is read from the new card 30. The peripheral region 32 in which the peripheral patterns 73 are printed makes it possible to surely recognize whether an identification pattern 72 is read from the new card 30. Incidentally, while a similar effect can be obtained by not printing patterns 71 in the peripheral region 32, the recognition can be performed more surely when the peripheral patterns 73 are printed. In addition, the processing of S102 can prevent an erroneous operation in a case where the peripheral patterns 73 are not read for some reason.

Incidentally, instead of using the same card flag, information decoded from a pattern 71 imaged by the camera 24 in previous processing may be stored, and when the information is not the same as information decoded from a pattern 71 imaged this time, the processing of controlling the operation of the moving body 20 according to the decoded card type may be performed. In this case, when information cannot be decoded from the image, storing dummy information in place of the information to be decoded makes it possible to deal with a case where the peripheral patterns 73 are not read for some reason.

Incidentally, not performing new control when the card type is read from the same card 30 is to prevent the occurrence of a problem and a waste of processing resources due to repetition of the same processing.

The description returns to the processing of FIGS. 18 and 19. After the processing of S128 is performed, the card determining section 53 determines whether the obtained operation instruction belongs to the group of the state change type (S131). When the obtained operation instruction belongs to the state change type (Y in S131), the parameter updating section 54 updates a traveling parameter according to the operation instruction (S132).

More specifically, the parameter updating section 54 updates the traveling parameter of a sub-group into which the operation instruction is classified to a value indicated by the operation instruction. When the operation instruction belongs to the speed sub-group, the parameter updating section 54 sets the speed parameter to a value corresponding to the operation instruction. When the operation instruction belongs to the steering sub-group, the parameter updating section 54 updates the steering state parameter to a value indicated by the operation instruction (for example, any one of the right, the left, and moving straight forward). When the operation instruction belongs to the brake sub-group, the parameter updating section 54 updates the brake parameter to the brake state (or the no-brake state).

When the operation instruction belongs to a plurality of sub-groups, the parameter updating section 54 updates the respective traveling parameters of the plurality of sub-groups to values indicated by the operation instruction. For example, when the operation instruction belongs to the speed sub-group and the steering sub-group, the parameter updating section 54 sets the speed parameter to a value corresponding to the operation instruction, and updates the steering state parameter to a value indicated by the operation instruction. In this case, there may be a plurality of operation instructions in one-to-one correspondence with respective combinations of candidate values of the speed parameter (for example, slow, fast, and very fast) and candidate values of the steering state parameter (for example, right, left, and moving straight forward). There may be cards 30 in one-to-one correspondence with the plurality of operation instructions, respectively.

When the obtained operation instruction does not belong to the state change type (N in S131), on the other hand, the card determining section 53 determines whether the obtained operation instruction represents an instruction to stop the moving body 20 (S133). When the operation instruction represents an instruction to stop the moving body 20 (Y in S133), the traveling processing section 55 ends traveling processing, and stops the moving body 20 (S134).

When the operation instruction does not represent an instruction to stop the moving body 20 (N in S133), on the other hand, the card determining section 53 determines whether the obtained operation instruction belongs to the group of the action type (S135). When the operation instruction does not belong to the group of the action type (N in S135), the processing of FIGS. 18 and 19 is ended. When the operation instruction belongs to the group of the action type (Y in S135), the card determining section 53 determines whether the traveling processing of the traveling processing section 55 or the action processing of the action processing section 56 is currently being performed (S136). When the traveling processing or the action processing is being performed (Y in S136), the traveling processing or the action processing being performed is stopped (S137). When neither the traveling processing nor the action processing is being performed (N in S136), the processing of S137 is skipped. Then, the action processing section 56 starts action processing according to the operation instruction (S138).

For an operation instruction to turn the traveling direction to a specified direction such as that of the card 30h in particular among the operation instructions of the action type, the action processing section 56 determines rotational directions and rotation amounts of the left and right motors 25 on the basis of the angle read from the card 30. The rotational directions and the rotation amounts are determined such that the orientation of the moving body 20 after rotation is a predetermined direction with respect to the card 30 from which the angle is read (for example, the direction of the arrow of the card 30h). Then, the action processing section 56 rotates the left and right motors 25 in the determined rotational directions and by the determined rotation amounts. When the rotation is ended, the processing of the traveling processing section 55 is resumed.

For an instruction to perform a fixed form of operation such as rotation (spinning), meandering traveling, or audio output among the operation instructions of the action type, the action processing section 56 first obtains time-series control information recorded in the storage 22 in association with the operation instruction of the action type. The action processing section 56 controls at least one of the motors 25 and the speaker 26 on the basis of the time-series control information. When this time-series control is ended, the processing of the traveling processing section 55 is resumed.

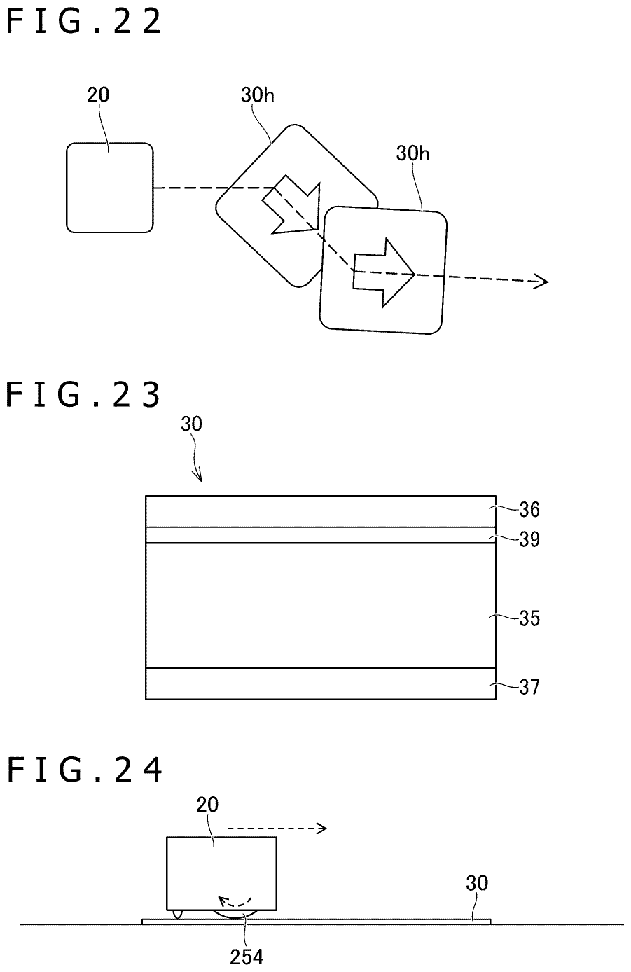

A description will be made of an example of processing in which the processing of the action processing section 56 and the obtainment of a card type from a new card 30 are combined with each other. FIGS. 21 and 22 are views of assistance in explaining examples of the operation of the moving body 20 for a plurality of arranged cards 30. In the example of FIG. 21, two cards 30s are arranged so as to partly overlap each other. The cards 30s are printed with an identification pattern 72 indicating the operation instruction of an action of producing sound. In the example of FIG. 21, the moving body 20 outputs sound when reading the identification pattern 72 for the first time on the left card 30s, and the moving body 20 outputs sound also on the right card 30s. By distinguishing whether or not the cards 30 are the identical card 30, it is possible to prevent a situation in which no sound is output at the right card 30s.

In the example of FIG. 22, two cards 30h are arranged so as to partly overlap each other while changing in direction. The cards 30h are printed with an identification pattern 72 indicating the operation instruction of an action of changing direction to the direction of an arrow. In the example of FIG. 22, the moving body 20 changes direction on a first card 30h, and thereafter changes direction also on a second card 30h. Also in such a case, by distinguishing whether or not the cards 30 are the identical card 30, it is possible to prevent a situation in which the second change of direction is not performed. Incidentally, in the example of FIG. 22, a difference between the cards 30 can be recognized from the angle in theory. However, because there is angle variation due to traveling, the difference between the cards 30 can be recognized easily and reliably by using the peripheral regions 32.

Even when the moving body 20 travels according to a traveling parameter set on the basis of a card 30, and moves away from the card 30, the processing of FIGS. 21 and 22 and the traveling processing depicted in FIG. 11 make it possible to control the traveling device so as to continue an operation corresponding to an operation instruction indicated by a previously read pattern 71 until the moving body 20 reads a new pattern 71 by traveling on a new card 30. Further, by combining using the peripheral regions 32 and not performing new control when an identification pattern 72 is read from the same card 30, it is possible to obtain information from a plurality of cards accurately, and perform simple operations with fewer operation errors.

### Example of Card Structure

A configuration of the card 30 will be described in the following. FIG. 23 is a schematic sectional view of the card 30. The card 30 has a strength such that the card 30 is difficult to bend. The friction coefficient of the underside surface of the card 30 is higher than the friction coefficient of the top side surface of the card 30.

The card 30 includes a plurality of sheets superposed on each other. The plurality of sheets include a base material 35, a top sheet 36, and an underside sheet 37. The top sheet 36 constitutes the top side surface of the card 30. The underside sheet 37 constitutes the underside surface of the card 30. The plurality of sheets are superposed in order of the top sheet 36, the base material 35, and the underside sheet 37 from above. A printing layer 39 is present between the base material 35 and the top sheet 36. An image that can be recognized by visible light and patterns 71 that can be recognized by infrared rays are printed as the printing layer 39 on the top side surface of the base material 35. The thickness of the card 30 is equal to or less than 0.45 mm, for example. It suffices for the thickness of the card 30 to be a thickness such that the moving body 20 can move onto the card 30 and such that it is difficult to bend the card 30.

The base material 35 may be a resin or paper. More specifically, the material of the base material 35 may be any one of paper, polypropylene (PP), polycarbonate (PC), polyethylene terephthalate (PET), and polyvinyl chloride (PVC). The material of the base material 35 may be selected from the above-described materials in consideration of a level of rigidity, durability, a price, smoothness (unlikeliness of the occurrence of a warp), and tolerance to heat.

The top sheet 36 and the underside sheet 37 are films affixed to the base material 35. The top sheet 36 and the underside sheet 37 may be formed by generally-called lamination, which affixes a film to the base material 35, or may be formed by coating. The material of the top sheet 36 may be the same as the material of the underside sheet 37. Specifically, these sheets may include the same kind of resin. Specifically, the material of the top sheet 36 and the underside sheet 37 may be one of PP and PET. The occurrence of a warp caused by a change in temperature or the like can be prevented when the top sheet 36 and the underside sheet 37 are of the same material.

Here, the underside surface of the card 30, that is, the underside sheet 37 has been subjected to surface processing that makes the friction coefficient of the underside surface of the card 30 higher than that of the top side surface of the card 30. For example, the top side surface of card 30 may be matted, and the underside surface may be coated with a material having a high friction coefficient. In addition, the underside surface may be matted, and the top side surface may not be processed. The matting may be performed by affixing a film having a rough surface (for example, a matted film) as the top sheet 36 or the underside sheet 37 to the base material 35, or may be performed by coating the top sheet 36 or the underside sheet 37 with one of materials such as a resin, a varnish, and a silicon-based ink. Velvet PP processing may be performed in place of the matting or the coating with the material.

These pieces of surface processing can increase the friction coefficient even when the underside surface of the card 30 is not coated with an adhesive for sealing. The friction coefficient of the undersurface of the card 30 may be made higher than that of the top surface thereof by printing onto the base material 35 and coating the base material 35 with a material in place of the surface processing using the top sheet 36 or the underside sheet 37. For example, printing of the printing layer 39 and coating with a protective layer (varnish) (only printing suffices) may be performed on the top surface of the base material 35, and the top surface of the base material 35 may be coated with a resin or a silicon-based ink having a higher friction coefficient. In this case, the card 30 may be constituted by one sheet formed of the base material 35.

FIG. 24 is a view of assistance in explaining an example of the moving body 20 traveling on the card 30. Suppose that in FIG. 24, the card 30 is disposed on a desk. When the moving body 20 travels on the card 30, a force in an opposite direction (rearward direction) from the traveling direction of the moving body 20 is transmitted to the card 30 due to a frictional force between the rotating wheels 254 and the card 30. When the frictional force between the card 30 and the desk is insufficient, the card 30 is displaced rearward. Increasing the friction coefficient of the underside surface of the card 30 raises a limit of a static frictional force between the card 30 and the desk, and can thus suppress the displacement of the card 30. In addition, decreasing the friction coefficient of the top side surface of the card 30 can reduce a possibility that an excessive force is transmitted to the card 30 and the position thereof is displaced when the moving body 20 makes an abrupt movement.

A planar configuration of the printing layer 39 will next be described. FIG. 17 depicts a view of assistance in explaining an example of an image printed on the card 30. As described earlier, the top side surface of the card 30 includes an inner region 31 surrounded by alternate long and short dashed lines in FIG. 17 and a peripheral region 32 located outside the alternate long and short dashed lines and surrounding the inner region 31. A plurality of patterns 71 are printed on the top side of the card 30 (the top side of the base material 35 to be exact) so as to be arranged in a matrix form. Each of the patterns 71 is an image of a predetermined size 0.2 mm square, for example. The patterns 71 are an image in which information for controlling the operation of the moving body 20 is coded. This information is also a card type. Details of the printing are the same as in the previous description, and therefore a description thereof will be omitted.

### Modification That Enables Recording and Reproduction

In the following, a description will be made of an example of recording and reproducing the operation of the moving body 20 by using cards 30. Parts not particularly described are similar to those of the embodiment described thus far.

In the present example, the plurality of cards 30 include a plurality of operation instruction cards, a recording start card, a recording end card, and a reproduction card. The recording start card, the recording end card, and the reproduction card are each printed with a coded image indicating an instruction to start or end recording or perform reproduction.

In the toy system according to the present embodiment, the camera 24 of the moving body 20 images a pattern 71 printed on a card 30, and the moving body 20 obtains information by decoding the pattern 71. Information obtained from a pattern 71 printed on an operation instruction card is an operation instruction. The moving body 20 thereby recognizes the type of the operation instruction card. Information obtained from the patterns 71 printed on the cards 30 indicating a start or an end of recording and reproduction is a recording start instruction, a recording end instruction, and a reproduction instruction, respectively. In addition, the moving body 20 detects the direction of the moving body 20 (for example, the angle A from the reference direction) by detecting an inclination of the patterns 71 present within an image imaged by the camera 24.

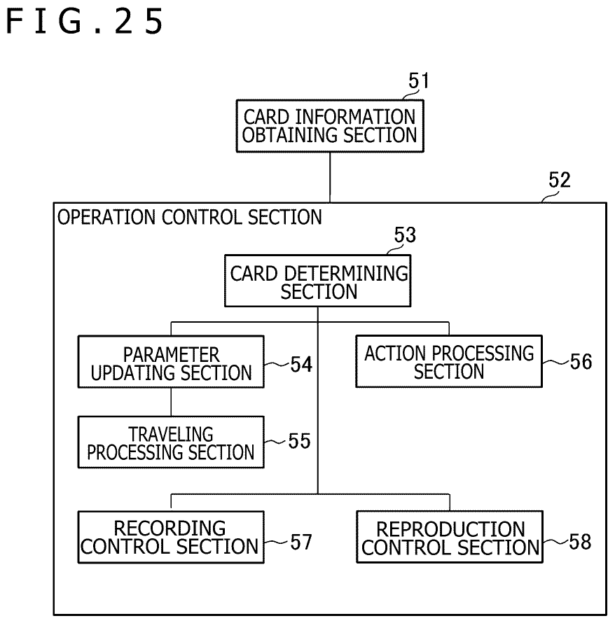

FIG. 25 is a block diagram depicting functions implemented by the toy system. In the present example, the toy system functionally has a card information obtaining section 51 and an operation control section 52. The operation control section 52 functionally includes a recording control section 57 and a reproduction control section 58 in addition to a card determining section 53, a parameter updating section 54, a traveling processing section 55, and an action processing section 56. These functions are mainly implemented by the processor 21 included in the moving body 20 by executing a program stored in the storage 22 and thereby controlling the camera 24, the motors 25, or the speaker 26. Incidentally, a part of these functions may be implemented by the processor 21 by transmitting a processing request to another computer included in the toy system via the communicating unit 23, and receiving the result.

The card information obtaining section 51 reads a pattern 71 (image) printed on a card 30, and obtains information indicated by the pattern 71. More specifically, when the moving body 20 travels on any one of the plurality of cards 30, the card information obtaining section 51 reads a pattern 71 printed on the card 30, and decodes information (an operation instruction, a recording start instruction, a recording end instruction, or a reproduction instruction) from the pattern 71. In addition, the card information obtaining section 51 obtains the orientation of the moving body 20 with respect to the card 30 on the basis of the inclination of the pattern 71 imaged by the camera 24.

In a case where the operation instruction is obtained as the information, the operation control section 52 controls the traveling device, the speaker 26, or the like according to the obtained operation instruction.

In a case where the recording start instruction is obtained, each time the moving body 20 reads a coded image by traveling on a new operation instruction card, the operation control section 52 additionally stores an operation instruction indicated by the image and time information indicating a present time in the storage 22 until a recording end condition is satisfied.

In a case where the reproduction instruction is obtained, the operation control section 52 controls the traveling device according to the time information and the operation instruction stored in the storage 22. In addition, in the case where the reproduction instruction is obtained, the operation control section 52 may control the traveling device according to the time information and the operation instruction stored in the storage 22 after controlling the traveling device so as to set the traveling device in an initial state stored in the storage 22.

In the case where the recording start instruction is obtained, each time the moving body 20 reads a coded image by traveling on a new operation instruction card, the recording control section 57 additionally stores an operation instruction indicated by the image and time information indicating the present time in the storage 22 until the recording end condition is satisfied. The recording start instruction may be obtained by reading an image indicating the recording start instruction from a pattern 71 printed on the recording start card. The recording end condition may be that the recording end instruction is obtained from a pattern 71 printed on the recording end card. The recording end condition may be that the moving body 20 stops or may be that a predetermined time passes. When the recording start instruction is obtained from a pattern 71 printed on the recording start card, the operation control section 52 may store an operation state (for example, a traveling parameter) of the moving body 20 at a time of the obtainment as an initial state in the storage 22.

In a case where the reproduction instruction is obtained, the reproduction control section 58 controls the traveling device according to the time information and the operation instruction stored in the storage 22. The reproduction instruction may be obtained by reading an image indicating the reproduction instruction from the reproduction card. In the case where the reproduction instruction is obtained, the traveling device may be controlled according to the time information and the operation instruction stored in the storage 22 after the traveling device is controlled so as to be set in an initial state stored in the storage 22.

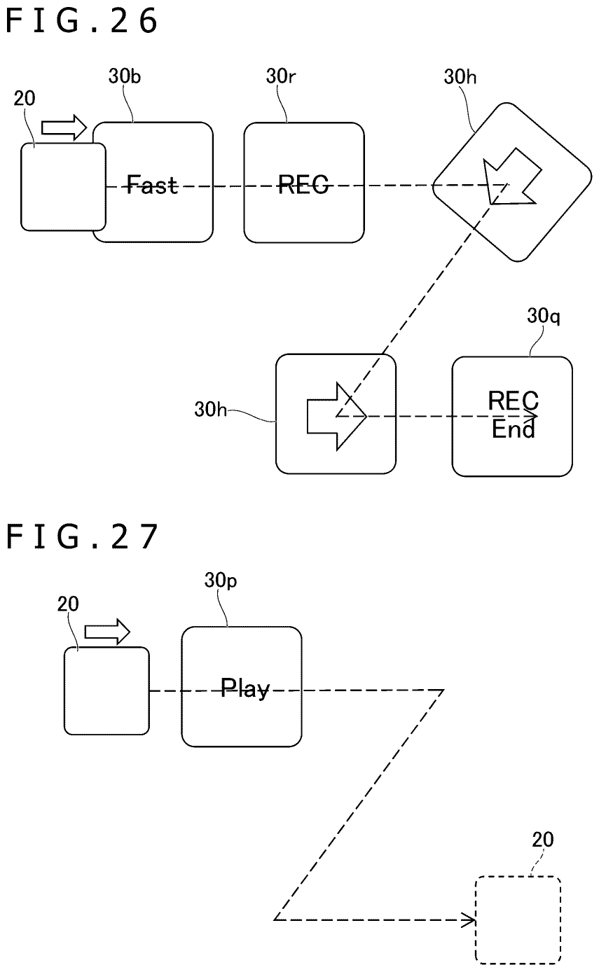

A description will next be made of an example of control of the moving body in a case where the recording start card, the recording end card, and the reproduction card are used. FIG. 26 is a view of assistance in explaining an example of recording of operation instructions. In the example of FIG. 26, a “Fast” card 30b and two arrow cards 30h indicating a change of direction are arranged as operation instruction cards. In addition, a card 30r is disposed as the recording start card, and a card 30q is disposed as the recording end card. In the example of FIG. 26, the moving body 20 passes the “Fast” card 30b and changes the speed to the second speed, thereafter reads the card 30r indicating a start of recording, and starts to record the subsequent operation instruction cards. The traveling parameter including the second speed is recorded as an initial state. After the recording is started, the moving body 20 reads the card 30h for effecting a change of direction to a lower left in the figure and changes direction, and reads the card 30h for effecting a change of direction to a right in the figure and changes direction. Thereafter, the moving body 20 moves straight forward and reads the card 30q indicating an end of the recording, and ends the recording. The recording control section 57 may stop the moving body 20 at the same time as the end of the recording.

FIG. 27 is a view of assistance in explaining an example of reproduction of the recorded operation instructions. In the example of FIG. 27, a card 30p as the reproduction card and an arrow card 30h indicating a change of direction as an operation instruction card are arranged. In the example of FIG. 27, when the moving body 20 reads the card 30p indicating the reproduction instruction, the moving body 20 reaches the second speed as an initial state, and moves as recorded in FIG. 26. In addition, the moving body 20 stops when ending the movement. Incidentally, there may be a card 30 indicating an instruction for repetitive reproduction in addition to the card 30p indicating the reproduction instruction. When the moving body 20 reads the card 30 indicating the instruction for repetitive reproduction, the moving body 20 does not stop at the end of the operation described with reference to FIG. 27 but repeats the recorded operation.

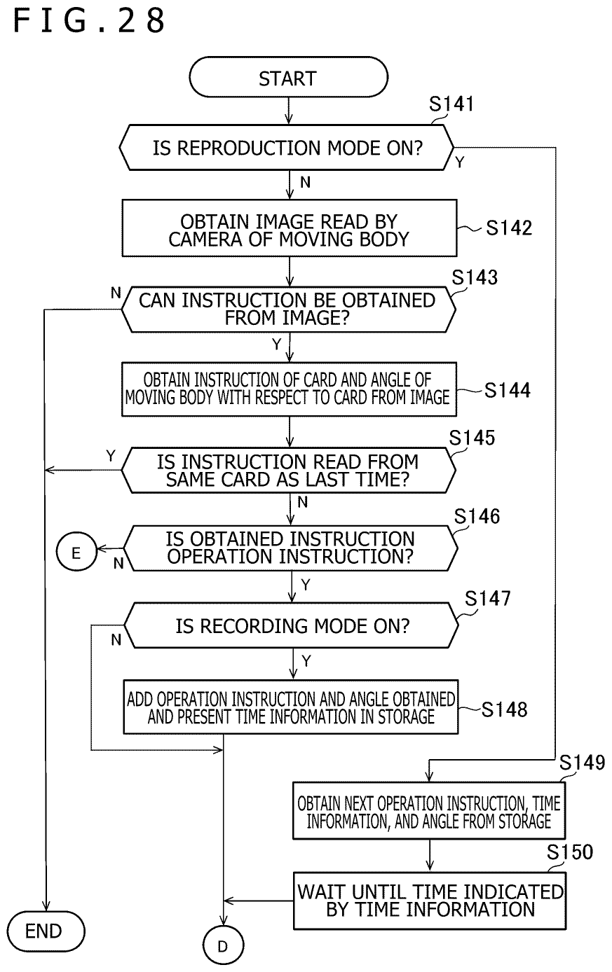

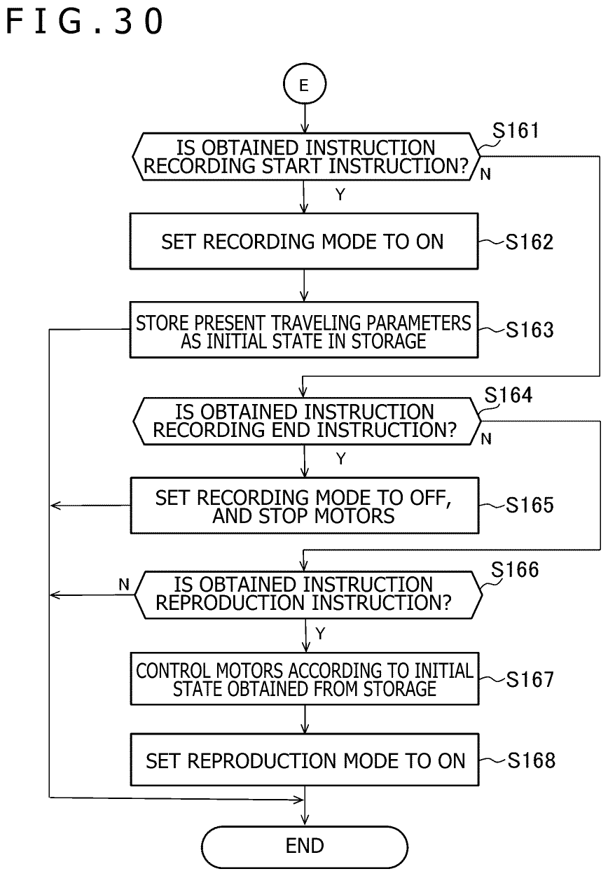

A more detailed description will next be made of processing for implementing the operation described thus far. FIGS. 28 to 30 are a flowchart depicting an example of processing of the moving body 20. FIGS. 28 to 30 mainly depict processing of the card information obtaining section 51, the card determining section 53, the parameter updating section 54, the recording control section 57, and the reproduction control section 58. The processing depicted in FIGS. 28 to 30 is repeated periodically (for example, at intervals of 0.1 seconds). In the example of FIGS. 28 to 30, there is a recording mode for recording an operation instruction during traveling and a reproduction mode for reproducing the recorded operation instruction in addition to a mode for normal traveling.

First, the reproduction control section 58 determines whether or not the reproduction mode is ON (S141). When the reproduction mode is ON (Y in S141), the reproduction control section 58 performs processing from S149 on down. Details of the processing will be described later.

When the reproduction mode is OFF (N in S141), the card information obtaining section 51 obtains an image read by the camera 24 of the moving body 20 (S142). The card information obtaining section 51 determines whether an instruction (an operation instruction, the recording start instruction, the recording end instruction, or the reproduction instruction) can be obtained from the obtained image (S143). More specifically, the card information obtaining section 51 determines whether there is a pattern 71 in the obtained image. When no instruction can be obtained (N in S143), the processing depicted in FIGS. 28 to 30 is ended. When an instruction can be obtained (Y in S143), the card information obtaining section 51 obtains the instruction of a card 30 and the angle A of the moving body 20 with respect to the card 30 from the image (S144). Processing using the angle A will be described later.

When the instruction of the card 30 is obtained, the card information obtaining section 51 determines whether the instruction is obtained from the same card 30 as last time (S145). When the instruction is obtained from the same card 30 (Y in S145), the processing of FIGS. 28 to 30 is ended. Whether or not the instruction is obtained from the same card 30 may be determined according to whether or not the same instruction is read at a time of the above-described reading. Here, when no information is read at a time of a previous reading, or the read information does not indicate any instruction, and the operation instruction is read this time, it is determined that the instruction is not read from the same card 30 as last time. This processing prevents the occurrence of a problem and a waste of processing resources due to repetition of the same processing.

When the obtained operation instruction is different from the operation instruction obtained last time (N in S145), the card determining section 53 determines whether the obtained instruction is an operation instruction (S146). Processing in a case where the obtained instruction is not an operation instruction will be described later.

When the obtained instruction is an operation instruction (Y in S146), the recording control section 57 determines whether the recording mode is ON (S147). When the recording mode is ON (Y in S107), the recording control section 57 adds the operation instruction and the angle A obtained by the card information obtaining section 51 and time information indicating the present time in the storage 22 (S148). When the recording mode is OFF (N in S147), the processing of S148 is skipped.

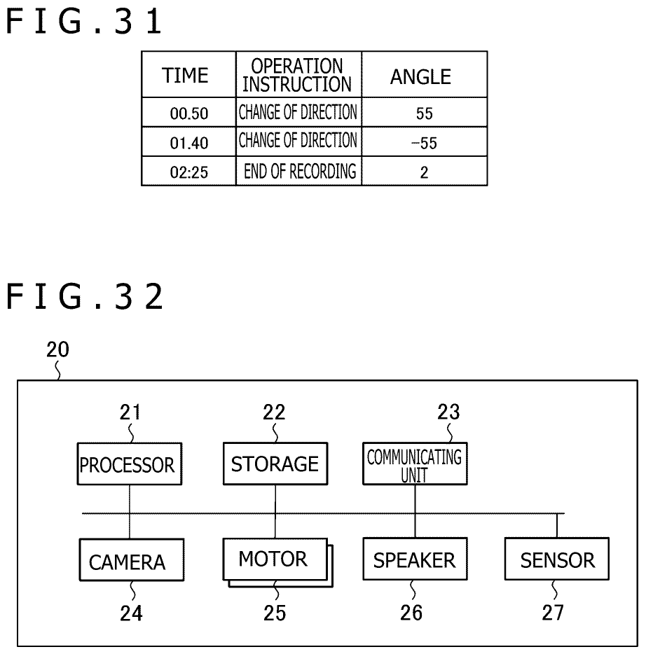

FIG. 31 is a view depicting an example of operation instructions and the like stored in the storage 22. The present view depicts, in a table format, an example of information stored in the storage 22 when the operation described in FIG. 26 is performed. A “time” field indicates time information. In the example of FIG. 31, the time information is a difference between a time at which an operation instruction is read and a recording start time. The time information may be the present time. In this case, a time at which the recording start instruction is obtained may be separately recorded as an initial state. The operation instruction is represented in a command format. In actuality, however, the operation instruction may be a binary code corresponding to a command, or may be information itself obtained by decoding a pattern 71. In the example of FIG. 31, the angle is represented in a format of −180 degrees to +180 degrees. However, the angle may be represented in a format of 0 to 360 degrees, or may be represented as an angle in n steps (n is an integer of 8 or more, for example) of one circle. In addition, also when the recording end instruction is obtained, the recording control section 57 may store the time information thereof or the like in the storage 22. In the example of FIG. 31, as an example thereof, a row described as “recording end” is depicted as an operation instruction. Incidentally, the storage 22 storing the operation instruction and the like may be a memory possessed by the moving body 20, for example.

When the reproduction mode is ON in S141 (Y in S141), the processing from S142 to S148 is not performed. In addition, the reproduction control section 58 obtains, from the storage 22, an earliest operation instruction (next operation instruction) among operation instructions yet to be read and the time information and the angle stored in association with the operation instruction (S149). In the processing from S151 to S158, the operation instruction and the angle are handled in a similar manner to those obtained in S144. The reproduction control section 58 waits until a time indicated by the time information (S150). Incidentally, though not depicted in the figure, when information indicating an end of recording in the storage 22 is read in S149, the reproduction control section 58 controls a traveling module so as to stop the moving body 20. In addition, in a case where the reproduction mode is set to ON as a result of reading an image indicating an instruction for repetitive reproduction from the repetitive reproduction card 30, the processing of S167 may be performed instead of the stopping when the information indicating the end of the recording in the storage 22 is read.

In a case of N in S147, or when the processing of S148 or S150 is ended, the card determining section 53 determines whether the obtained operation instruction belongs to the group of the state change type (S151). When the obtained operation instruction belongs to the state change type (Y in S151), the parameter updating section 54 updates a traveling parameter according to the operation instruction (S152).

More specifically, the parameter updating section 54 updates the traveling parameter of a sub-group into which the operation instruction is classified to a value indicated by the operation instruction. When the operation instruction belongs to the speed sub-group, the parameter updating section 54 sets the speed parameter to a value corresponding to the operation instruction. When the operation instruction belongs to the steering sub-group, the parameter updating section 54 updates the steering state parameter to a value indicated by the operation instruction (for example, any one of the right, the left, and moving straight forward). When the operation instruction belongs to the brake sub-group, the parameter updating section 54 updates the brake parameter to the brake state (or the no-brake state).

When the operation instruction belongs to a plurality of sub-groups, the parameter updating section 54 updates the respective traveling parameters of the plurality of sub-groups to values indicated by the operation instruction. For example, when the operation instruction belongs to the speed sub-group and the steering sub-group, the parameter updating section 54 sets the speed parameter to a value corresponding to the operation instruction, and updates the steering state parameter to a value indicated by the operation instruction. In this case, there may be a plurality of operation instructions in one-to-one correspondence with respective combinations of candidate values of the speed parameter (for example, slow, fast, and very fast) and candidate values of the steering state parameter (for example, right, left, and moving straight forward). There may be cards 30 in one-to-one correspondence with the plurality of operation instructions, respectively.

When the obtained operation instruction does not belong to the state change type (N in S151), on the other hand, the card determining section 53 determines whether the obtained operation instruction represents an instruction to stop the moving body 20 (S153). When the operation instruction represents an instruction to stop the moving body 20 (Y in S153), the traveling processing section 55 ends traveling processing, and stops the moving body 20 (S154). After the processing of S154 is performed, the processing of FIGS. 28 to 30 is ended.

When the operation instruction does not represent an instruction to stop the moving body 20 (N in S153), on the other hand, the card determining section 53 determines whether the obtained operation instruction belongs to the group of the action type (S155). When the operation instruction does not belong to the group of the action type (N in S155), the processing of FIGS. 28 to 30 is ended. When the operation instruction belongs to the group of the action type (Y in S155), the card determining section 53 determines whether the traveling processing of the traveling processing section 55 or the action processing of the action processing section 56 is currently being performed (S156). When the traveling processing or the action processing is being performed (Y in S156), the traveling processing or the action processing being performed is stopped (S157). When neither the traveling processing nor the action processing is being performed (N in S156), the processing of S157 is skipped. Then, the action processing section 56 starts action processing according to the operation instruction (S158). An example of the action processing will be described later.

When the instruction obtained by the card information obtaining section 51 is not an operation instruction in S146 (N in S146), the card determining section 53 determines whether the obtained instruction is the recording start instruction (S161). When the obtained instruction is the recording start instruction (Y in S161), the recording control section 57 sets the recording mode to ON (S162), and stores the present traveling parameters as an initial state in the storage 22 (S163). The processing of FIGS. 28 to 30 is then ended.

When the obtained instruction is not the recording start instruction (N in S161), the card determining section 53 determines whether the obtained instruction is the recording end instruction (S164). When the obtained instruction is the recording end instruction (Y in S164), the recording control section 57 sets the recording mode to OFF, and stops the motors 25 (S165). The processing of FIGS. 28 to 30 is then ended.

When the obtained instruction is not the recording end instruction (N in S164), the card determining section 53 determines whether the obtained instruction is the reproduction instruction (S166). When the obtained instruction is the reproduction instruction (Y in S166), the reproduction control section 58 obtains initial state information from the storage 22, and controls the motors 25 according to the obtained initial state (for example, the traveling parameters) (S167). More specifically, the reproduction control section 58 updates the traveling parameters according to the obtained initial state, and controls the rotation of the motors 25 such that the traveling state of the moving body 20 becomes the initial state, or in other words, such that a rotational state of the wheels 254 corresponds to the speed and the steering orientation indicated by the traveling parameters. The reproduction control section 58 then sets the reproduction mode to ON (S168).

In FIGS. 28 to 30, the processing of S146, S161, S164, and S166 may be performed in another order. In addition, the processing of S151, S153, and S155 may be performed in another order.

In the embodiment described thus far, operations can be reproduced easily and faithfully by recording operation instructions and time information read during actual traveling of the moving body 20, and reproducing the operation instructions and the time information instead of recording the positions of arranged cards 30 or the like. In addition, the reproduction of recordings can be handled as a subroutine. A programming experience gained by arranging cards 30 can be thereby made more diversified and advanced.

In the example of FIGS. 28 to 30, whether the recording mode is on or off, a new operation instruction is ignored when the new operation instruction is the same as the last operation instruction (see the order of S145 and S147). These pieces of processing can suppress the occurrence of a difference between operation at a time of performing recording or at a time of not performing recording and operation at a time of reproduction while more simply reducing the capacity of the storage 22 necessitated by recording.

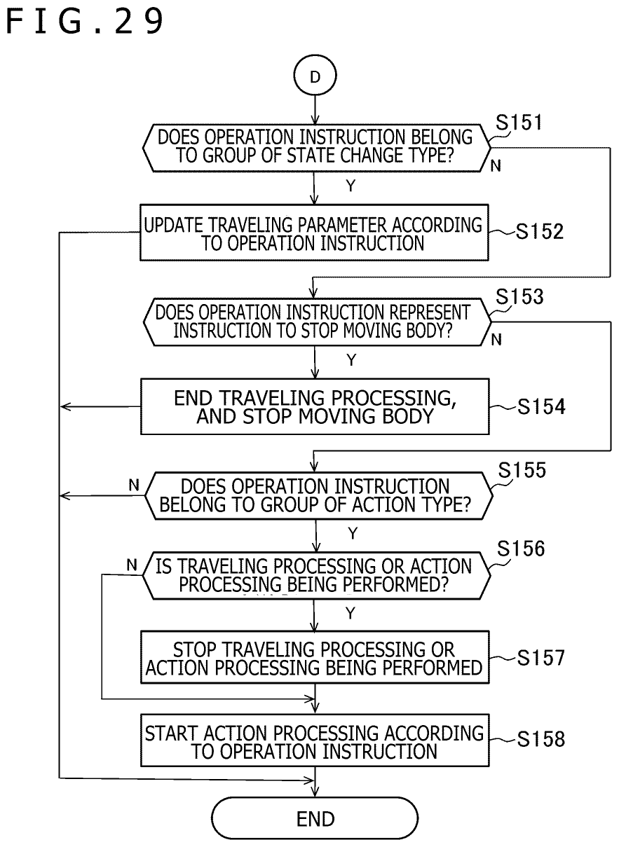

Incidentally, details of the traveling processing in response to the processing of FIGS. 28 to 30 and the action processing started in S158 in FIG. 29 are respectively similar to those described with reference to FIG. 11 and FIG. 16. Hence, a description of details of these pieces of processing will be omitted. However, when the recording mode is ON in S204, the same processing as in the case where the recording end instruction is obtained (see S165) may be performed. In addition, in S302, the action processing section 56 determines the rotational directions and the rotation amounts of the left and right motors 25 on the basis of the angle read from the card 30 or the angle obtained in S149.

### Modification Enabling Interrupt Processing

In the following, a description will be made of an example of controlling the operation of the moving body 20 by using interrupt processing. Parts not particularly described are similar to those of the embodiment described thus far.

The plurality of cards 30 include a plurality of operation instruction cards, a plurality of interrupt setting cards, and an interrupt execution card. Each of the plurality of operation instruction cards is printed with an image indicating an instruction for an operation of the moving body 20 (operation instruction). Each of at least a part of the plurality of operation instruction cards is printed with a coded image indicating any one of the plurality of operation instructions for the moving body 20.

The interrupt setting cards are cards for setting a kind of interrupt processing. The interrupt processing is referred to also as event processing. The plurality of interrupt setting cards correspond to a plurality of interrupt execution conditions on a one-to-one basis. Each of the plurality of interrupt setting cards is printed with a coded image indicating an interrupt setting instruction for a corresponding interrupt execution condition. The interrupt execution condition is an event as a trigger for set processing. The interrupt execution card is an instruction (execution instruction) corresponding to a specific one of the plurality of interrupt execution conditions, and is printed with a coded image indicating the execution instruction.

FIG. 32 is a view depicting an example of a hardware configuration of the toy system. The moving body 20 includes a sensor 27 in addition to a processor 21, a storage 22, a communicating unit 23, a camera 24, two motors 25, and a speaker 26.

The sensor 27 includes at least one of an acceleration sensor and a magnetic sensor. The acceleration sensor is, for example, a six-axis acceleration sensor, and detects acceleration applied to the moving body 20. An overturn of the moving body 20 and an impact on the moving body 20 are detected on the basis of output of the acceleration sensor. The magnetic sensor is, for example, a three-axis magnetic sensor, and may be installed, for example, under the top surface of the moving body 20.

With regard to FIG. 4 already described, in the toy system according to the present embodiment, the camera 24 of the moving body 20 images a pattern 71 printed on the card 30, and the moving body 20 obtains information by decoding the pattern 71. Information obtained from a pattern 71 printed on an operation instruction card is an operation instruction. The moving body 20 thereby recognizes the type of the operation instruction card. Information obtained from a pattern 71 printed on an interrupt setting card is an interrupt setting instruction for a corresponding interrupt execution condition. Information obtained from a pattern 71 printed on an interrupt execution card is an execution instruction corresponding to a specific one of a plurality of interrupt execution conditions, and is printed with a coded image indicating the execution instruction.

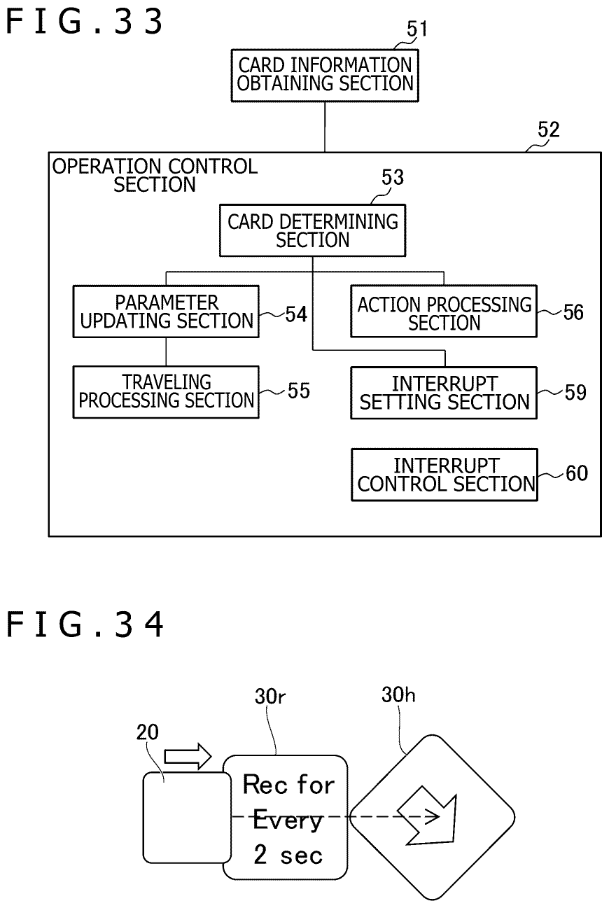

FIG. 33 is a block diagram depicting functions implemented by the toy system. The operation control section 52 functionally includes an interrupt setting section 59 and an interrupt control section 60 in addition to the card determining section 53, the parameter updating section 54, the traveling processing section 55, and the action processing section 56. These functions are mainly implemented by the processor 21 included in the moving body 20 by executing a program stored in the storage 22 and thereby controlling the camera 24, the motors 25, the speaker 26, or the sensor 27. Incidentally, a part of these functions may be implemented by the processor 21 by transmitting a processing request to another computer included in the toy system via the communicating unit 23, and receiving the result.

As described earlier, the card information obtaining section 51 reads a pattern 71 (image) printed on a card 30, and obtains information indicated by the pattern 71. More specifically, when the moving body 20 travels on any one of a plurality of cards 30, the card information obtaining section 51 reads a pattern 71 printed on the card 30, and decodes information (an operation instruction, an interrupt setting instruction, or an execution instruction) from the pattern 71.

As described earlier, in a case where the operation instruction is obtained as the information, the operation control section 52 controls the traveling device, the speaker 26, or the like according to the obtained operation instruction. In a case where the operation instruction is information indicating a change in a traveling parameter, the operation control section 52 controls the traveling device (motors 25) according to the changed parameter after the obtainment of the pattern 71 from which the operation instruction is obtained. In addition, in a case where no coded pattern 71 is read, the operation control section 52 controls the traveling device so as to continue an operation corresponding to an operation instruction indicated by a previously read pattern 71 until the moving body 20 reads a new coded pattern 71 by traveling on a new card 30 among the plurality of cards 30. When the new coded pattern 71 is read, the operation control section 52 controls the traveling device according to a new operation instruction, an interrupt setting instruction, or an execution instruction indicated by the new pattern 71.

In a case where the interrupt setting instruction is obtained, the operation control section 52 stores an operation instruction indicated by an image read from an operation instruction card on which the moving body 20 travels next in the storage 22 in association with an interrupt execution condition corresponding to the interrupt setting instruction.

When any one of the interrupt execution conditions is satisfied, the operation control section 52 performs an operation corresponding to an operation instruction stored in the storage 22 in association with the satisfied interrupt execution condition, and after performing the operation, makes the traveling device resume an operation before the satisfaction of the interrupt execution condition.

The card determining section 53 determines which kind of instruction is indicated by the information of a card 30 obtained by the processing of the card information obtaining section 51. In addition, when the information indicates an operation instruction, the card determining section 53 determines a group to which the operation instruction belongs.

In a case where the interrupt setting instruction is obtained, the interrupt setting section 57 obtains an operation instruction indicated by an image read from an operation instruction card on which the moving body 20 travels next and the orientation of the moving body 20, and stores an interrupt execution condition corresponding to the interrupt setting instruction, the operation instruction, and the orientation in the storage 22 in association with each other. The interrupt execution condition includes at least a part of one or a plurality of time intervals for execution, the detection of an impact by the acceleration sensor, the detection of magnetism satisfying a detection condition by the magnetic sensor, and the reading of a special pattern 71. The special pattern 71 may be printed on the interrupt execution card, and the pattern 71 may be an image in which an execution instruction is coded. In a case where a pattern 71 indicating an interrupt recording instruction is read, the interrupt setting section 57 first makes the moving body 20 travel in a predetermined direction on the basis of the orientation of the moving body 20 obtained from the inclination of the imaged pattern 71. Then, the interrupt setting section 57 stores an operation instruction and a direction indicated by an image read from an operation instruction card disposed in a predetermined direction in the storage 22 in association with the interrupt execution condition. Incidentally, the interrupt setting cards may be printed with a visually recognizable image indicating a direction in which a next card is disposed.

When any one of the interrupt execution conditions is satisfied, the interrupt control section 58 performs an operation corresponding to an operation instruction stored in the storage 22 in association with the satisfied interrupt execution condition. This operation may be an operation performed according to the operation instruction during normal traveling, may be control of the traveling device, or may be output of sound by the speaker 26. In addition, after performing the operation, the interrupt control section 58 makes the traveling device resume an operation (for example, an operation corresponding to a traveling parameter) before the interrupt execution condition is satisfied.

A case of using an interrupt setting card and an interrupt execution card will next be described. FIG. 34 is a view of assistance in explaining an example of setting an interrupt operation. In the example of FIG. 34, an arrow card 30h indicating a change of direction is disposed as an operation instruction card. In addition, a card 30r is disposed as the interrupt setting card. In the example of FIG. 34, the interrupt execution condition is a time interval of two seconds (every two seconds), and an interrupt operation for the interrupt execution condition is recorded. More specifically, the moving body 20 reads the card 30r indicating an interrupt setting, and travels forward. Next, the moving body 20 reads the card 30h that effects a change of direction obliquely to the right, and stores the operation instruction and the angle obtained from the card 30h in the storage 22 in association with the interrupt execution condition of a time interval of two seconds.

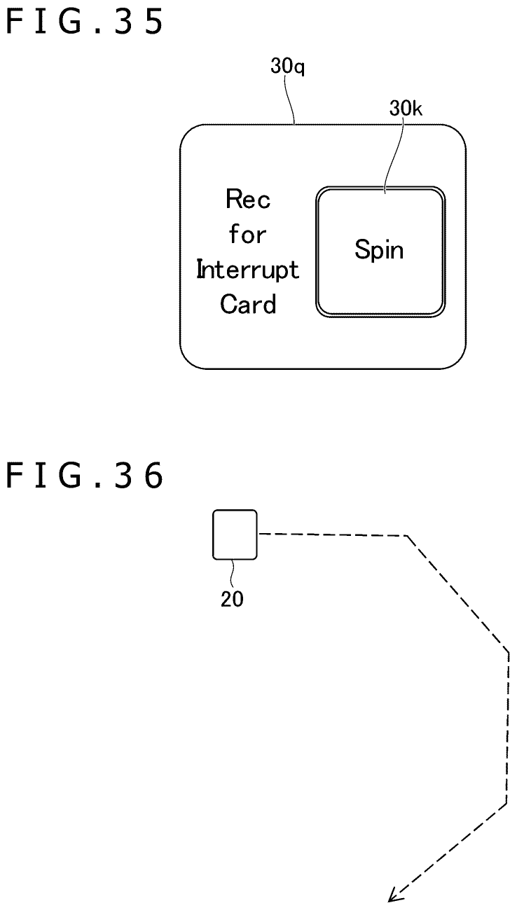

FIG. 35 is a view depicting a modification of an interrupt setting card. As depicted in FIG. 35, a card 30q as an interrupt setting card may be provided with an opening having a size and shape corresponding to an operation instruction card, and an operation instruction card may be fitted to the opening. In the example of FIG. 35, a card 30k indicating an operation instruction of the action type, which operation instruction indicates rotation, is fitted to the opening. An interrupt execution condition corresponding to the interrupt setting card in FIG. 35 is to read an interrupt execution card.

In a case where the moving body 20 reads an interrupt setting instruction from the interrupt setting card, the moving body 20 next obtains the operation instruction from the operation instruction card fitted to the opening, and stores the operation instruction and the interrupt execution condition of reading the interrupt execution card in the storage 22 in association with each other.

FIG. 36 is a view of assistance in explaining an example of operation according to the interrupt setting depicted in FIG. 34. In the example of FIG. 36, an operation instruction indicating a change of direction and information indicating an angle of an oblique right representing a direction to which a change is to be made are stored in association with the interrupt execution condition of a time interval of two seconds. The operation instruction is performed every two seconds, and the moving body 20 changes direction to an obliquely right direction. In addition, after the change of direction, forward movement is resumed in a similar manner to that before the change of direction. A path in which the moving body 20 travels is consequently as indicated by a broken line in FIG. 36.

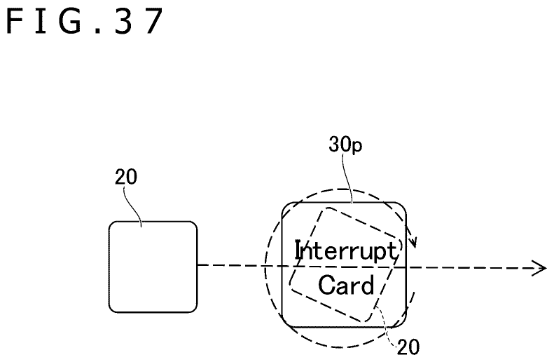

FIG. 37 is a view of assistance in explaining an example of operation according to the interrupt execution card. In FIG. 37, a card 30p is disposed as the interrupt execution card. In addition, suppose that as depicted in FIG. 35, an operation instruction for one rotation is stored in association with an interrupt execution condition of reading the interrupt execution card. In the example of FIG. 37, when the moving body 20 reads a pattern 71 of the interrupt execution card after moving straight forward, the moving body 20 rotates. Then, the moving body 20 moves straight forward again after the rotation. An operation similar to that of the rotation card 30k can be made to be performed by the interrupt execution card. Thus, it is also possible to practically increase the number of operation instruction cards of a specific kind.

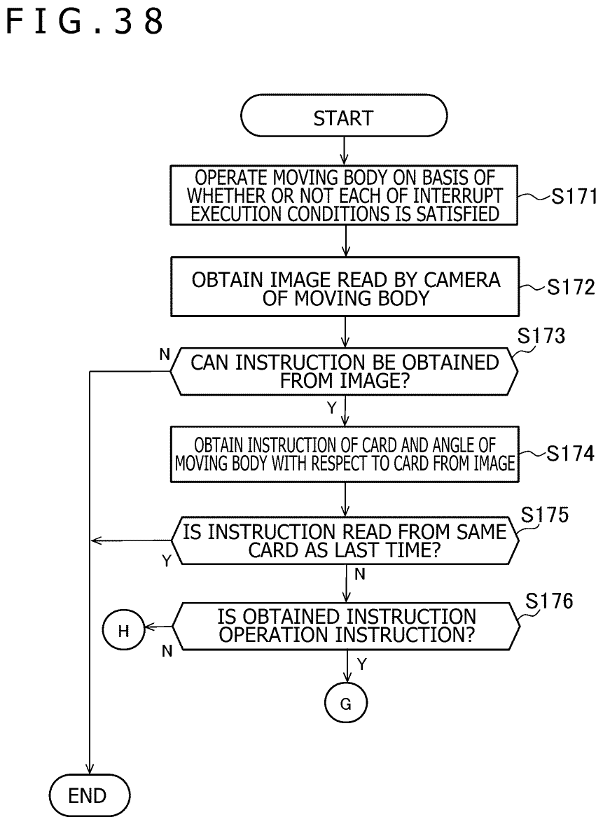

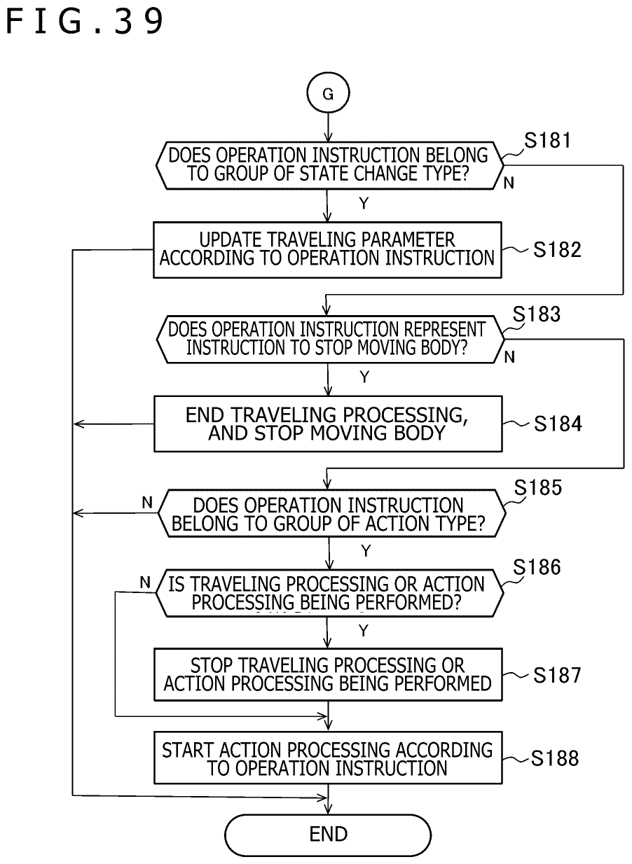

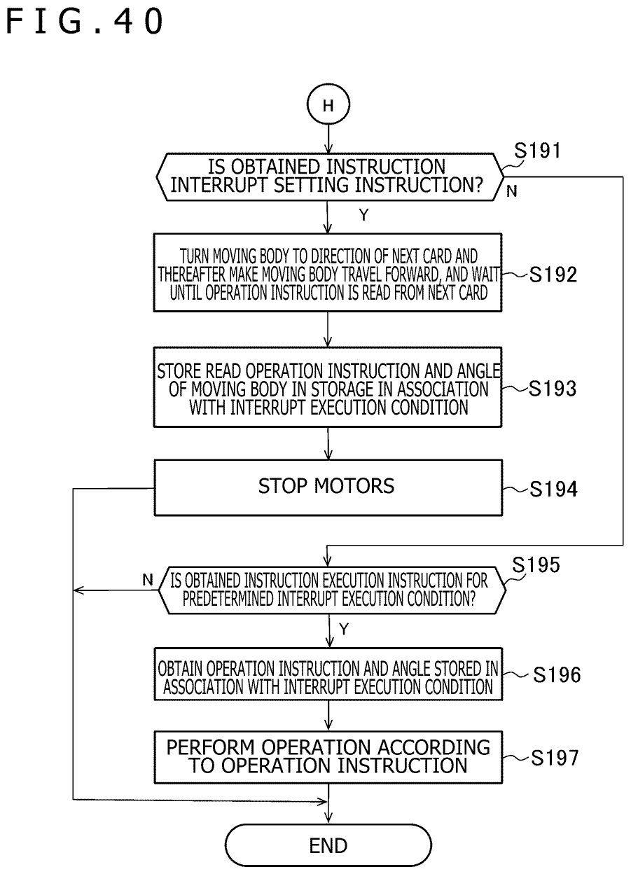

A more detailed description will next be made of processing for implementing the operation described thus far. FIGS. 38 to 40 are a flowchart depicting an example of processing of the moving body 20. FIGS. 38 to 40 mainly depict processing of the card information obtaining section 51, the card determining section 53, the parameter updating section 54, the interrupt setting section 57, and the interrupt control section 58. The processing depicted in FIGS. 38 to 40 is repeated periodically (for example, at intervals of 0.1 seconds). However, the repetition of the processing may be suppressed while an operation involved in an interrupt setting instruction or an operation corresponding to an interrupt execution condition is performed.

First, the interrupt control section 58 makes the moving body 20 operate according to whether or not each of the plurality of interrupt execution conditions is satisfied (S171). To be exact, the plurality of interrupt execution conditions as a target of the processing exclude the reading of the interrupt execution card. Details of this processing will be described later.

Next, the card information obtaining section 51 obtains an image read by the camera 24 of the moving body 20 (S172). The card information obtaining section 51 determines whether an instruction (an operation instruction, an interrupt setting instruction, or an interrupt execution instruction) can be obtained from the obtained image (S173). More specifically, when there is a pattern 71 in the obtained image, and information decoded from the image indicates a certain instruction (for example, indicates a value in a range allocated to instructions), the card information obtaining section 51 determines that an instruction can be obtained. When no instruction can be obtained (N in S173), the processing depicted in FIGS. 13 to 15 is ended. When an instruction can be obtained (Y in S173), the card information obtaining section 51 obtains the instruction of a card 30 and the angle A of the moving body 20 with respect to the card 30 from the image (S174). Processing using the angle A will be described later.

When the instruction of the card 30 is obtained, the card information obtaining section 51 determines whether the instruction is obtained from the same card 30 as last time (S175). When the instruction is obtained from the same card 30 (Y in S175), the processing of FIGS. 13 to 15 is ended. Whether or not the instruction is obtained from the same card 30 may be determined according to whether or not the same instruction is read. Further, it may be determined that the instruction is not read from the same card 30 as last time when no instruction is read last time. This processing prevents the occurrence of a problem and a waste of processing resources due to repetition of the same processing.

When the instruction is not read from the same card 30 as last time (N in S175), the card determining section 53 determines whether the obtained instruction is an operation instruction (S176). Processing in a case where the obtained instruction is not an operation instruction will be described later.

When the obtained instruction is an operation instruction (Y in S176), the card determining section 53 determines whether the obtained operation instruction belongs to the group of the state change type (S181). When the obtained operation instruction belongs to the state change type (Y in S181), the parameter updating section 54 updates a traveling parameter according to the operation instruction (S182).

When the obtained operation instruction does not belong to the state change type (N in S181), on the other hand, the card determining section 53 determines whether the obtained operation instruction represents an instruction to stop the moving body 20 (S183). When the operation instruction represents an instruction to stop the moving body 20 (Y in S183), the traveling processing section 55 ends traveling processing, and stops the moving body 20 (S184).

When the operation instruction does not represent an instruction to stop the moving body 20 (N in S183), on the other hand, the card determining section 53 determines whether the obtained operation instruction belongs to the group of the action type (S185). When the operation instruction does not belong to the group of the action type (N in S185), the processing of FIGS. 38 to 40 is ended. When the operation instruction belongs to the group of the action type (Y in S185), the card determining section 53 determines whether the traveling processing of the traveling processing section 55 or the action processing of the action processing section 56 is currently being performed (S186). When the traveling processing or the action processing is being performed (Y in S186), the traveling processing or the action processing being performed is stopped (S187). When neither the traveling processing nor the action processing is being performed (N in S186), the processing of S187 is skipped. Then, the action processing section 56 starts action processing according to the operation instruction (S188). An example of the action processing will be described later.

When the instruction obtained by the card information obtaining section 51 is not an operation instruction in S176 (N in S176), the card determining section 53 determines whether the obtained instruction is an interrupt setting instruction (S191). When the obtained instruction is an interrupt setting instruction (Y in S191), the interrupt setting section 57 controls the traveling device such that the moving body 20 turns to the direction of a next card 30, and thereafter travels forward. The interrupt setting section 57 waits until the card information obtaining section 51 reads an operation instruction (and an angle) from a next card 30 (S192). The user disposes the next card 30 in a predetermined direction (for example, the right direction of a card 30 in FIG. 26 or 27) with respect to the interrupt setting card. The interrupt setting section 57 controls the traveling device such that the moving body 20 turns to a predetermined direction on the basis of the angle A obtained by the card information obtaining section 51 from the inclination of the imaged pattern 71 of the interrupt setting card. The interrupt setting section 57 then makes the traveling device travel forward in that direction. The turn to the direction makes it possible to read an operation instruction card even when a direction in which the moving body 20 is placed is shifted.

When the operation instruction is read, the interrupt setting section 57 stores the operation instruction and the angle in the storage 22 in association with an interrupt execution condition corresponding to the interrupt setting instruction (S193). In addition, the interrupt setting section 57 stops the motors 25 (S194), and ends the processing of FIGS. 38 to 40.

When the obtained instruction is not an interrupt setting instruction (N in S191), the card determining section 53 determines whether the obtained instruction is an execution instruction for a predetermined interrupt execution condition (S195). When the obtained instruction is the execution instruction (Y in S195), the interrupt control section 58 obtains an operation instruction and an angle stored in association with the interrupt execution condition from the storage 22, and controls at least a part of the traveling device and the speaker 26 so as to perform an operation corresponding to the operation instruction (S197).

The processing described thus far makes it possible not only to simply operate the moving body 20 according to the instructions of cards 30 but also to make settings so as to operate the moving body 20 according to various interrupt execution conditions. This improves a degree of freedom of programming, and can make a programming experience gained by arranging cards 30 more diversified and advanced.

The traveling processing of the traveling processing section 55 is similar to that described with reference to FIG. 11. The processing depicted in FIG. 11 is periodically performed except during a stop state or the execution of an operation involved in the action processing, an operation involved in an interrupt setting instruction, or an operation corresponding to an interrupt execution condition.

The action processing is similar to that described with reference to FIG. 16, and therefore a detailed description thereof will be omitted.

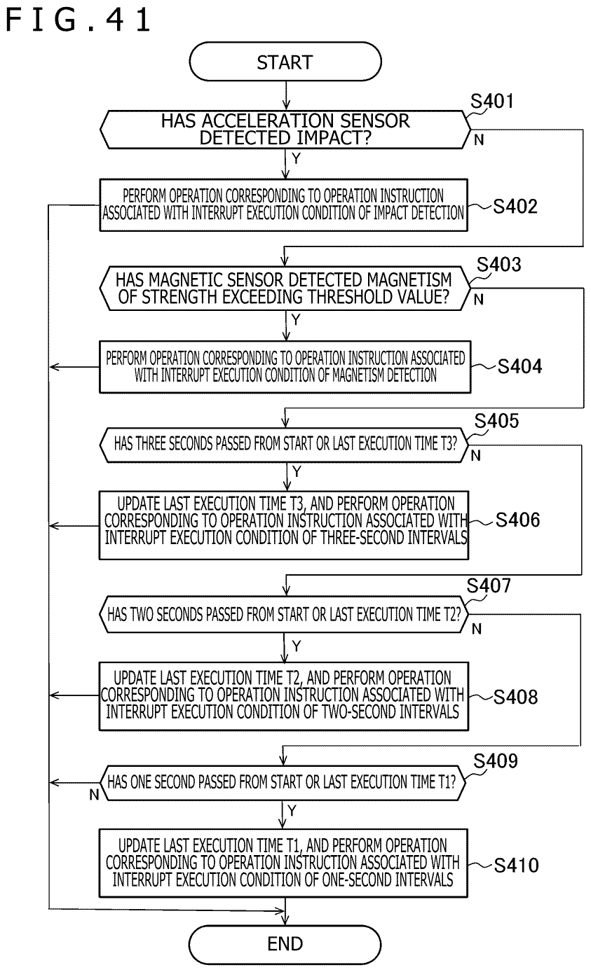

FIG. 41 is a flowchart depicting an example of processing for operating the moving body 20 according to the interrupt execution conditions.

First, the interrupt control section 58 determines whether the acceleration sensor has detected an impact on the moving body 20 (S401). The detection of an impact is any one of the plurality of interrupt execution conditions. When an impact is detected (Y in S401), the interrupt control section 58 performs an operation corresponding to an operation instruction (and an angle) associated with the interrupt execution condition of impact detection (S402). More specifically, the interrupt control section 58 obtains the operation instruction and the angle stored in association with the interrupt execution condition from the storage 22, and controls at least a part of the traveling device and the speaker 26 so as to perform an operation corresponding to the operation instruction.

When no impact is detected (N in S401), the interrupt control section 58 determines whether the magnetic sensor has detected a magnetism of a strength exceeding a threshold value (S403). The detection of a magnetism is any one of the plurality of interrupt execution conditions. When a magnetism of a strength exceeding the threshold value is detected (Y in S403), the interrupt control section 58 performs an operation corresponding to an operation instruction (and an angle) associated with the interrupt execution condition of magnetism detection (S404).

When no magnetism exceeding the threshold value is detected (N in S403), the interrupt control section 58 determines in S405 whether an interrupt execution condition of a three-second interval is satisfied. In actuality, the interrupt control section 58 determines whether three seconds have passed from a start of operation or a last execution time T3. The start of the operation may be a time point at which the moving body 20 is disposed on a desk, for example. The execution time T3 is a time at which this interrupt execution condition is satisfied last time. The interrupt control section 58 may determine whether the interrupt execution condition of a three-second interval is satisfied simply according to whether or not an elapsed time from the start of the operation is divisible by three seconds. When three seconds have passed from a start of traveling or the last execution time T3 (Y in S405), the interrupt control section 58 performs an operation corresponding to an operation instruction (and an angle) associated with the interrupt execution condition of a three-second interval (S406).

When three seconds have not passed from the start of traveling or the last execution time T3 (N in S405), the interrupt control section 58 determines in S407 whether an interrupt execution condition of a two-second interval is satisfied. In actuality, the interrupt control section 58 determines whether two seconds have passed from the start of the operation or a last execution time T2. The execution time T2 is a time at which this interrupt execution condition is satisfied last time. The interrupt control section 58 may determine whether the interrupt execution condition of a two-second interval is satisfied simply according to whether or not the elapsed time from the start of the operation is divisible by two seconds. When two seconds have passed from the start of traveling or the last execution time T2 (Y in S407), the interrupt control section 58 performs an operation corresponding to an operation instruction (and an angle) associated with the interrupt execution condition of a two-second interval (S408).

When two seconds have not passed from the start of traveling or the last execution time T2 (N in S407), the interrupt control section 58 determines in S409 whether an interrupt execution condition of a one-second interval is satisfied. In actuality, the interrupt control section 58 determines whether one second has passed from the start of the operation or a last execution time T1. The execution time T1 is a time at which this interrupt execution condition is satisfied last time. The interrupt control section 58 may determine whether the interrupt execution condition of a one-second interval is satisfied simply according to whether or not the elapsed time from the start of the operation is divisible by one second. When one second has passed from the start of traveling or the last execution time T1 (Y in S409), the interrupt control section 58 performs an operation corresponding to an operation instruction (and an angle) associated with the interrupt execution condition of a one-second interval (S409).

The order of the processing of S401 to S402, S403 to S404, and S405 to S410 may be different from that depicted in FIG. 18. However, the processing from S405 to S410 is preferably in order in which the processing is preferentially performed for a longer time interval. For example, when two seconds have passed from the start of the operation, the interrupt execution conditions of not only a two-second interval but also a one-second interval are satisfied. However, when priority is given to the operation corresponding to the interrupt execution condition of a one-second interval, the operation of a two-second interval is not performed, which lacks in variety. In addition, complex operation in a cycle of a least common multiple can be implemented by combining the operations of a plurality of time intervals, so that more various programming can be performed.

As is understood from the description thus far, it is possible not only to simply operate the moving body 20 according to the instructions of cards 30 but also operate the moving body 20 according to interrupt execution conditions such as a specific card, time intervals, impact detection, and period detection. For example, a change can be incorporated into operation by using a time interval, and an operation for dealing with an obstacle or the like is programmed by using, for example, impact detection and period detection. There thus arises room for various contrivances. Consequently, a degree of freedom of programming is improved, and a programming experience gained by arranging cards 30 can be made more diversified and advanced.

1-10. (canceled)

11. A system for controlling a moving body, the system comprising:
one or more processors; and
a non-transitory processor-readable medium storing instructions that, when executed by the one or more processors that, when executed by the one or more processors, cause the system to:
receive, from a reading module of the moving body, a coded image printed on an operation instruction card, the coded image being readable by the reading module as the moving body is caused to travel over the operation instruction card,
control operations of a traveling module of the moving body in real-time in accordance with a first operation instruction encoded in a first coded image printed on a first operation instruction card as read by the reading module, and
when the moving body is caused to travel over a second operation instruction card and a second coded image printed on the second operation instruction card is read by the reading module, modify the operations of the traveling module in accordance with the second operation instruction,
wherein controlling operations of the traveling module comprises causing the travel module to continue the operations according to the first operation instructions until the second coded image is read by the reading module.

12. The system of claim 11, wherein the operation instructions include one or more of a steering instruction, a speed instruction, a brake instruction, a traveling direction, a recording instruction, a recording end instruction, a reproduction instruction, an interrupt setting instruction, and an interrupt end instruction.

13. The system of claim 12, wherein the system is further caused to:
upon receipt of the recording instruction, initiate a recording mode to record the operation instructions associated with the coded images printed on one or more operation instruction cards over which the moving body is caused to travel; and
upon receipt of the recording end instruction, terminate the recording mode.

14. The system of claim 13, wherein the system is further caused to:
upon receipt of the reproduction instruction, cause the traveling module to perform operations according to operation instructions recorded during the recording mode.

15. The system of claim 13, wherein the system is further caused to:
upon receipt of the recording instruction and prior to initiating the recording mode, store an initial operation state of the traveling module; and
after performing operation instructions recorded during the recording mode, return the traveling module to the initial operation state.

16. The system of claim 12, wherein, upon receipt of the interrupt setting instruction, the system is further caused to:
interrupt operations of the traveling body at a time of receipt of the interrupt setting instruction,
store a subsequent operation instruction associated with a coded image printed on a subsequent operation instruction card over which the moving body is caused to travel,
control the traveling body to perform operations according to the subsequent operation instruction, and
upon completion of the operations according to the subsequent operation instruction, return the traveling module to operations at the time of receipt of the interrupt setting instruction.

17. The system of claim 16, wherein storing the subsequent operation instruction further comprises:
initiating an interrupt mode,
storing subsequent operation instructions associated with coded images printed on subsequent operation instruction cards over which the moving body is caused to travel until a predetermined execution condition has been met.

18. The system of claim 17, wherein the predetermined execution condition comprises one or more of the interrupt end instruction, passage of a predetermined amount of time from receipt of the interrupt setting instruction, and detection of a magnetic field associated with a detection condition.

19. The system of claim 11, further comprising a plurality of operation instruction cards, each one of the plurality of operation instruction cards comprising:
an inner region printed with a plurality of identification patterns indicating the operation instruction associated with the one of the plurality of operation instruction cards; and
a peripheral region at least partially surrounding the inner region, the peripheral region including peripheral information different from the inner region.

20. A method for controlling a moving body, the method comprising:
receiving, from a reading module of the moving body, a coded image printed on an operation instruction card, the coded image being readable by the reading module as the moving body is caused to travel over the operation instruction card,
controlling operations of a traveling module of the moving body in real-time in accordance with a first operation instruction encoded in a first coded image printed on a first operation instruction card as read by the reading module, and
when the moving body is caused to travel over a second operation instruction card and a second coded image printed on the second operation instruction card is read by the reading module, modifying the operations of the traveling module in accordance with the second operation instruction,
wherein controlling operations of the traveling module comprises causing the travel module to continue the operations according to the first operation instructions until the second coded image is read by the reading module.

21. The method of claim 20, wherein the operation instructions include one or more of a steering instruction, a speed instruction, a brake instruction, a traveling direction, a recording instruction, a recording end instruction, a reproduction instruction, an interrupt setting instruction, and an interrupt end instruction.

22. The method of claim 21, further comprising:
upon receipt of the recording instruction, initiating a recording mode to record the operation instructions associated with the coded images printed on one or more operation instruction cards over which the moving body is caused to travel; and
upon receipt of the recording end instruction, terminating the recording mode.

23. The method of claim 22, further comprising:
upon receipt of the reproduction instruction, causing the traveling module to perform operations according to operation instructions recorded during the recording mode.

24. The method of claim 22, further comprising:
upon receipt of the recording instruction and prior to initiating the recording mode, storing an initial operation state of the traveling module; and
after performing operation instructions recorded during the recording mode, returning the traveling module to the initial operation state.

25. The method of claim 22, further comprising, upon receipt of the interrupt setting instruction:
interrupting operations of the traveling body at a time of receipt of the interrupt setting instruction,
storing a subsequent operation instruction associated with a coded image printed on a subsequent operation instruction card over which the moving body is caused to travel,
controlling the traveling body to perform operations according to the subsequent operation instruction, and
upon completion of the operations according to the subsequent operation instruction, return the traveling module to operations at the time of receipt of the interrupt setting instruction.

26. The method of claim 25, wherein storing the subsequent operation instruction further comprises:
initiating an interrupt mode,
storing subsequent operation instructions associated with coded images printed on subsequent operation instruction cards over which the moving body is caused to travel until a predetermined execution condition has been met.

27. The method of claim 26, wherein the predetermined execution condition comprises one or more of the interrupt end instruction, passage of a predetermined amount of time from receipt of the interrupt setting instruction, and detection of a magnetic field associated with a detection condition.

28. A non-transitory computer-readable medium storing executable instructions that, when executed by one or more processors, cause the one or more processors to:
receive, from a reading module of a moving body, a coded image printed on an operation instruction card, the coded image being readable by the reading module as the moving body is caused to travel over the operation instruction card,
control operations of a traveling module of the moving body in real-time in accordance with a first operation instruction encoded in a first coded image printed on a first operation instruction card as read by the reading module, and
when the moving body is caused to travel over a second operation instruction card and a second coded image printed on the second operation instruction card is read by the reading module, modify the operations of the traveling module in accordance with the second operation instruction,
wherein controlling operations of the traveling module comprises causing the travel module to continue the operations according to the first operation instructions until the second coded image is read by the reading module.

29. The non-transitory computer-readable medium of claim 28, wherein the operation instructions include one or more of a steering instruction, a speed instruction, a brake instruction, a traveling direction, a recording instruction, a recording end instruction, a reproduction instruction, an interrupt setting instruction, and an interrupt end instruction.

30. The non-transitory computer-readable medium of claim 29, wherein the one or more processors is further caused to:
upon receipt of the recording instruction, initiate a recording mode to record the operation instructions associated with the coded images printed on one or more operation instruction cards over which the moving body is caused to travel; and
upon receipt of the recording end instruction, terminate the recording mode.
